(19) United States
(12) Patent Application Publication
(10) Pub. No.: US 2026/0257781 A1
(43) Pub. Date: Sep. 3, 2026

(54) MOTOR COOLING SYSTEM

(71) Applicant: GUANGDONG EPROPULSION TECHNOLOGY LIMITED, Dongguan (CN)

(72) Inventors: Haiyang WANG, Dongguan (CN); Hao TAN, Dongguan (CN); Dong XU, Dongguan (CN); Xiaokang WAN, Dongguan (CN); Shizheng TAO, Dongguan (CN)

(73) Assignee: GUANGDONG EPROPULSION TECHNOLOGY LIMITED, Dongguan (CN)

(21) Appl. No.: 19/630,446

(22) Filed: Mar. 27, 2026

Related U.S. Application Data
(63) Continuation of application No. PCT/CN2023/123823, filed on Oct. 10, 2023.

(51) Int. Cl. B63H 20/28; B63H 21/17

(52) U.S. Cl. CPC B63H 20/28; B63H 21/17

(57) ABSTRACT

A motor cooling system for a motorized vessel or vehicle is provided. The motor cooling system includes an engine, a pump, and a sealed chamber. The engine includes a motor and a speed gearbox. The sealed chamber encases the motor and the speed gearbox. The sealed chamber is configured to store a cooling liquid. The pump is configured to receive the cooling liquid in the sealed chamber and send the cooling liquid to the speed gearbox for temperature control when the engine is in operation.

### CROSS-REFERENCE TO RELATED APPLICATION

This application is a continuation of International Application No. PCT/CN2023/123823, filed on Oct. 10, 2023. The entire contents of the above-referenced application are expressly incorporated herein by reference.

### TECHNICAL FIELD

The present disclosure relates generally to a cooling system, and more specifically, to a motor cooling system that stores, maintains, and circulates a cooling liquid to keep a running motor from overheating.

### BACKGROUND

Electric outboard motors, such as trolling motors, are a popular marine propulsion device often used as a supplemental power source in a fishing or sports vessel. These electric outboard motors typically include a propulsion unit submerged in a body of water, which is supported by a mount assembled and controlled by a steering unit. This submerged propulsion unit generally includes an electric motor configured to drive a propeller to provide the thrust to steer the vessel.

During operation, the electric motor generates significant thermal energy. The motors in related art rely on the surrounding water to keep the motor from overheating. The motors may utilize internal configurations that result in inefficient thermal transfer between the motor and the external environment. This thermal inefficiency can lead to overheating, reduced performance, and a shortened operational lifespan for the motor components. Therefore, there is a need for an improved cooling system for electric outboard motors that enhances heat dissipation.

### SUMMARY

Accordingly, it is an objective of the present application to teach an advanced cooling system that effectively keeps a running engine from overheating.

In some embodiments, an electric motor cooling system is disclosed. The electric motor cooling system comprises an electric motor, a speed gearbox operatively coupled to the electric motor, and a sealed chamber encasing the electric motor and the speed gearbox and serving as a storage for storing a cooling liquid, and a stirring component disposed inside the sealed chamber. The stirring component is configured to transfer momentum to the cooling liquid to allow the cooling liquid to spread over at least one of the electric motor or the speed gearbox when the electric motor is in operation. In some embodiments, the stirring component is a component of the speed gearbox. One or more gears of the speed gearbox are configured to transfer momentum to the cooling liquid when in operation so that the cooling liquid spreads over at least one of the electric motor or the speed gearbox and the cooling liquid absorbs thermal energy from at least one of the electric motor or the speed gearbox.

In other embodiments, the stirring component is a component of the electric motor. A rotor of the electric motor is configured to stir the cooling liquid when in operation such that the cooling liquid spreads over at least one of the electric motor or the speed gearbox and the cooling liquid absorbs thermal energy from at least one of the electric motor or the speed gearbox.

In some embodiments, the electric motor cooling system is used in a boat and is at least partially submerged in water during an operation of the boat. When the boat is at least partially disposed in the water, the electric motor cooling system is configured to exchange thermal energy with the water. The cooling liquid functions as a coolant and a lubricant for at least one of the electric motor or the speed gearbox. For example, the cooling liquid is in fluid communication with the electric motor or the speed gearbox to provide thermal dissipation and lubrication. The electric motor and the speed gearbox each define one or more orifices through which the cooling liquid reaches internal parts of the electric motor or the speed gearbox for lubrication and heat exchange.

In some embodiments, the electric motor cooling system further comprises a pump that is disposed in the sealed chamber and is configured to fluidly receive the cooling liquid from a bottom portion of the sealed chamber and to pump the received cooling liquid to an upper portion of the sealed chamber that is above at least one of the electric motor or the speed gearbox. The pump is a mechanical pump or an electrical pump and is disposed between the electric motor and the speed gearbox. The pump may be one of the following mechanical pumps: a gear pump, a plunger pump, a cycloid gear pump, or a vane pump. The pump is configured to receive the cooling liquid through one or more inlet ports. The pump includes a filter in at least one of the one or more inlet ports to filter out debris collected from the cooling liquid. The filter may be a suction filter or a press filter. In one embodiment, the filter comprises a magnet to retain metal debris collected from the cooling liquid.

In some embodiments, one or more outlet ports of the pump may be disposed in proximity to the electric motor, where a portion of the pumped cooling liquid output from the one or more outlet ports contacts interior portions of the electric motor to perform at least one of cooling or lubricating the electric motor. In some embodiments, one or more outlet ports of the pump are disposed in proximity to the speed gearbox, where a portion of the pumped cooling liquid output from the one or more outlet ports contacts interior portions or parts of the speed gearbox to perform at least one of cooling or lubricating the gearbox. The pump may further comprise one or more valves, each of the one or more valves being disposed inside an outlet port of the pump to control a flow rate of the cooling liquid flowing through the outlet port.

The pump may be a gear pump that comprises a lower casing, an upper casing, an inner gear, an outer gear, and one or more washers that are assembled along a shaft of the orbital pump. The gear pump may be a gerotor pump. Inside the gerotor pump, the inner gear is configured with n teeth and the outer gear is configured with n+1 teeth, with n being an integer larger than 2. The teeth of the inner gear interlock with the teeth of the outer gear. During operation, the inner gear is driven by a gear motor and is configured to rotate in two directions and to drive the outer gear through friction generated between the interlocked teeth of the inner and outer gear. An axis of the inner gear may be off-center relative to an axis of the outer gear and is configured to shift as the inner gear rotates. The inner gear when driven by the gear motor creates a shifting space between the inner gear and the outer gear to pump the cooling liquid through the gerotor pump.

The cooling system may further comprise a middle casing that is fluidly coupled with the electric motor and the speed gearbox, and outputs the cooling liquid onto the electric motor and/or the speed gearbox. The middle casing may comprise a storage bin for storing cooling liquid that is pumped out of the middle casing. The middle casing may be configured with an upper shaft hole and a lower shaft hole. The upper shaft hole of the middle casing is coupled with an upper gear shaft of the speed gearbox and the lower shaft hole of the middle casing is coupled with a lower gear shaft of the speed gearbox. The cooling liquid in the storage bin of the middle casing flows through the upper shaft hole and the lower shaft hole in a direction towards the speed gearbox.

The pump may further comprise a cam plate that is coupled with the middle casing through the upper shaft hole and the lower shaft hole to distribute the cooling liquid from the pump to the middle casing. In some embodiments, the middle casing is fluidly coupled with the electric motor through a liquid distributor. The liquid distributor is configured with one or more input ports that are fluidly coupled with the one or more outlet ports of the pump, respectively. The liquid distributor is disposed above or proximate to a rotor of the electric motor. In one embodiment, the liquid distributor defines a plurality of orifices for dripping the cooling liquid onto the rotor and the plurality of orifices are evenly distributed across a length of the liquid distributor thereby facilitating for the cooling liquid to be output over a length of the rotor. The plurality of orifices may be evenly distributed along a circumference of the liquid distributor.

In one embodiment, the middle casing defines an outlet coupled to a cooling device for cooling at least a portion of the cooling liquid.

Another embodiment contemplates a boat comprising any of the motor cooling system described above. Yet another embodiment contemplates a motorized vessel that comprises any of the motor cooling system described above.

In some embodiments, a motor cooling system is disclosed. The motor cooling system comprises an engine that includes a speed gearbox and a motor, a sealed chamber encasing the motor and the speed gearbox and serving as a storage for storing a cooling liquid, and a pump configured to receive the cooling liquid from the storage and to output the received cooling liquid over the speed gearbox, for example, when the engine is in operation. The pump may be further configured to output the received cooling liquid over the motor, for example, when the engine is in operation.

In one embodiment, the motor and the speed gearbox are separately installed in a first region and a second region of the sealed chamber respectively. The first region is above the second region, and a portion of the storage extends beneath the second region where the speed gearbox is installed. In this embodiment, the cooling liquid stored in the storage is substantially constrained within the second region and does not come into contact with the motor.

In some embodiments, one or more rotors of the motor may be encased in a sealed cover to prevent the rotors from contact with the cooling liquid, and a stator and a shaft of the motor are in contact with the cooling liquid.

In some embodiments, the motor cooling system may be installed on a boat, and the storage of the cooling liquid extends downward within a keel of the boat and the lowest point of the storage is inside the keel. An inlet of the pump may be located at the lowest point of the storage thereby facilitating the pump to receive the cooling liquid when the boat is in a pitching position, and allowing the inlet of the pump to remain below the surface of the cooling liquid to ensure the inlet is submerged in the cooing liquid when the boat is in a pitching position.

A region of the keel may be used as a part of the storage and defines a flat area that includes two contact surfaces on opposing sides of the flat region, the two contact surfaces serving as heat-exchange surfaces between the cooling liquid and surrounding water when the boat on which the motor cooling system is installed is in operation.

The motor cooling system may further comprise a tank. The tank is installed above the surface of the cooling liquid in the storage. The tank stores a portion of the cooling liquid. A tank pump is configured to draw the cooling liquid from the storage into the tank. The tank is also configured with an outlet through which the cooling liquid stored in the tank drips onto at least one of the motor or the speed gearbox.

The motor cooling system may be installed in a boat. When the boat is in motion, the storage is configured with a movable inlet that remains submerged in the cooling liquid. The movable inlet is a cylindrical tube and includes a weight attached to an end of the cylindrical tube to ensure the cylindrical tube staying submerged in the cooling liquid.

In one embodiment, the motor cooling system is installed in a boat, where the storage is configured with a pair of pumps and two inlets that are positioned a distance apart. Each inlet is connected to one pump in the pair of pumps respectively. The two inlets are so positioned so that when the boat is in motion, at least one of the two inlets is submerged in the cooling liquid and the corresponding pump connected to the at least one inlet submerged in the cooling liquid is in operation to pump the cooling liquid from the storage into the tank.

In one embodiment, the inlet corresponding to a first pump of the pair of pumps is located in the front of the storage and the inlet corresponding to a second pump of the pair of pumps is located at the back of the storage, and at least one of the first pump or the second pump is in operation when the corresponding inlet is submerged in the cooling liquid.

The tank may be further configured with an overflow port to allow the cooling liquid to flow into the storage located below the tank to prevent the tank from overflowing. In one embodiment, the flow rate of the first pump is larger than the flow rate of the overflow port, and the flow of the overflow port is larger than the flow of the second pump.

The motor cooling system may be installed in an underwater pod and an exchange valve is disposed on the bottom surface of the underwater pod to facilitate at least one of draining or changing the cooling liquid. An exchange tube connects to the storage at one end and connects to outside of the underwater pod at another end. The exchange tube is used to receive the cooling liquid from the storage when the exchange tube is connected to an outside pump when at least one of draining or changing the cooling liquid is performed.

The motor cooling system may further comprise an above-water electric cooling device. The above-water electric cooling device is disposed in an above-water electronic control bay in an above-water powerhead. The above-water electric cooling device may include a tube bundle arranged in a honey-comb style. The cooling liquid received from the storage passes through spaces in between the tubes in the tube bundle and exchanges heat with the tube surfaces of the tube bundle. The motor cooling system may further comprise a cooling coil that wraps around a cylindrical structure. The cylindrical structure connects the above-water electronic cooling device with the motor cooling system. When the cylindrical structure is submerged in water, the cooling coil allows the cooling liquid to exchange thermal energy with surrounding water when it passes through the cooling coil. The above-water electronic cooling device may be configured to further reduce a temperature of the cooling liquid before the cooling liquid is directed to the above-water electronic control bay to reduce a temperature of the electronic equipment inside the electronic control bay. In one embodiment, the above-water electronic cooling device comprises a dual panel structure, and the electronic equipment is disposed on an outer surface of each panel in the dual panel structure and a space between two panels in the dual panel structure accommodates a passage for the cooling liquid. When in operation, the motor cooling system drives the cooling liquid to flow through the passage between the two panels to reduce the temperature of the electronic equipment.

In one embodiment, the set of electronic equipment disposed on one panel of the dual panel structure may be a mirror system of the set of electronic equipment disposed on the other panel of the dual panel structure to implement a failover function.

In one embodiment, a set of electronic equipment may be disposed on each panel of the dual panel structure and each set of electronic equipment is electrically connected to the motor to control an operation of the motor. The motor may be a dual-rotor motor thereby providing an increased horsepower, e.g., doubling the horsepower of the motor. Each set of electronic equipment is electrically connected to a rotor in the dual-rotor motor to control the operation of the rotor.

The above-water electronic control bay may further house one or more panels of electronic control circuits and the cooling liquid is used to reduce the temperature of the one or more panels of electronic control circuits. The cooling coil is connected to the above-water electronic cooling device via a rubber tube and the rubber tube is configured to conduct the cooling liquid from the cooling coil to the above-water electronic control bay.

In one embodiment, the above-water electronic control bay is encased in a thermal silica cover that protects the above-water electronic control bay from the cooling liquid and absorbs thermal energy of the above-water electronic control bay. The absorbed thermal energy is dissipated into the cooling liquid through the thermal silica cover. The above-water electronic cooling device may comprise a filter at an entrance of the above-water electronic cooling device to filter out metallic debris collected from the cooling liquid. In some implementations, the cooling coil is connected to a secondary pump for pumping the cooling liquid through the cooling coil and into the above-water electronic cooling device. The thermal silica cover may be configured with an air duct that is fluidly connected to an air pressure pump to control the air pressure within the above-water electronic control bay.

In some embodiments, a check valve may be disposed at either an inlet or an outlet of the above-water electronic cooling device. The check valve is configured to retain a portion of the cooling liquid inside the above-water electronic cooling device when the motor cooling system is disabled. The retained cooling liquid enables the above-water electronic cooling device to function when the operation of the motor cooling system resumes.

The above-water electronic cooling device further comprises an air piston to adjust air pressure inside the motor cooling system. The motor cooling system may be connected to a steering gear system of a boat to adjust a temperature of the steering gear system and/or used as a lubricate to lubricate the steering gear system. The cooling liquid may be oil and is pumped into the steering gear system as a coolant and a lubricant. The motor cooling system may be used to store the lubricant for the steering gear system.

In some embodiments, the motor cooling system is connected to a tilt-and-trim system of a boat and the cooling liquid is pumped from the motor cooling system to the tilt-and-trim system to adjust a temperature of the tilt-and-trim system. In one embodiment, the cooling liquid is oil and the oil is pumped into the tilt-and-trim system as a coolant and a lubricant.

In one embodiment, the motor cooling system is installed in a boat, and the cooling liquid, after absorbing thermal energy from the engine, is directed to a heating system of the boat to adjust the temperature of a living quarter inside the boat.

Embodiments of the motor cooling system disclosed in the present application can be used in any motorized vessels such as boats, ships, yachts, vehicles, etc.

### BRIEF DESCRIPTION OF THE DRAWINGS

These and other features of the present disclosure will become readily apparent upon further review of the following specification and drawings. In the drawings, like reference numerals designate corresponding parts throughout the views. Moreover, components in the drawings are not necessarily drawn to scale, the emphasis instead being placed upon clearly illustrating the principles of the present disclosure.

FIG. 1 is an illustration of a motorized vessel.

FIG. 2 illustrates an embodiment of a motor cooling system disclosed in the present application.

FIG. 3 illustrates another embodiment of a motor cooling system disclosed in the present application.

FIG. 4A-FIG. 4E illustrate embodiments of a pump used in the motor cooling system disclosed in the present application.

FIG. 5A-FIG. 5C illustrate how the pump can be coupled with the engine in different embodiments of the motor cooling system disclosed in the present application.

FIG. 6A-FIG. 6C illustrate a gerotor pump used in embodiments of the motor cooling system disclosed in the present application,

FIG. 7A-FIG. 7C illustrate an inlet and a filter disposed at the inlet in embodiments of the motor cooling system disclosed in the present application.

FIG. 8A-FIG. 8C illustrate a middle casing being coupled with a liquid distributor in embodiments of the motor cooling system disclosed in the present application.

FIG. 9A-FIG. 9F illustrate embodiments of the motor cooling system in which the cooling liquid is directed to different above-water parts of a motorized vessel.

FIG. 10A-FIG. 10C are block diagrams illustrating a circulation route of the cooling liquid in the motor cooling system as disclosed in embodiments of the present application.

FIG. 11 illustrates an embodiment in which the cooling liquid is used as lubricant in an electric motor.

FIG. 12A-FIG. 12H are block diagrams illustrating embodiments of the motor cooling system configured to function properly during various movements of the motorized vessel.

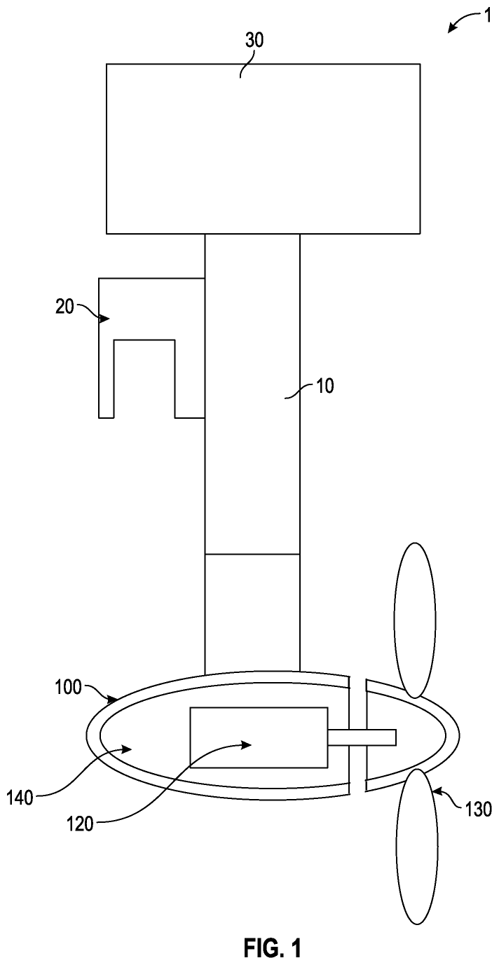

### DETAILED DESCRIPTION

Embodiments of the disclosure are described more fully hereinafter with reference to the accompanying drawings, in which embodiments of the disclosure are shown. The various embodiments of the disclosure may, however, be embodied in many different forms and should not be construed as limited to the embodiments set forth herein. Rather, these embodiments are provided so that this disclosure will be thorough and complete, and will fully convey the scope of the disclosure to those skilled in the art.

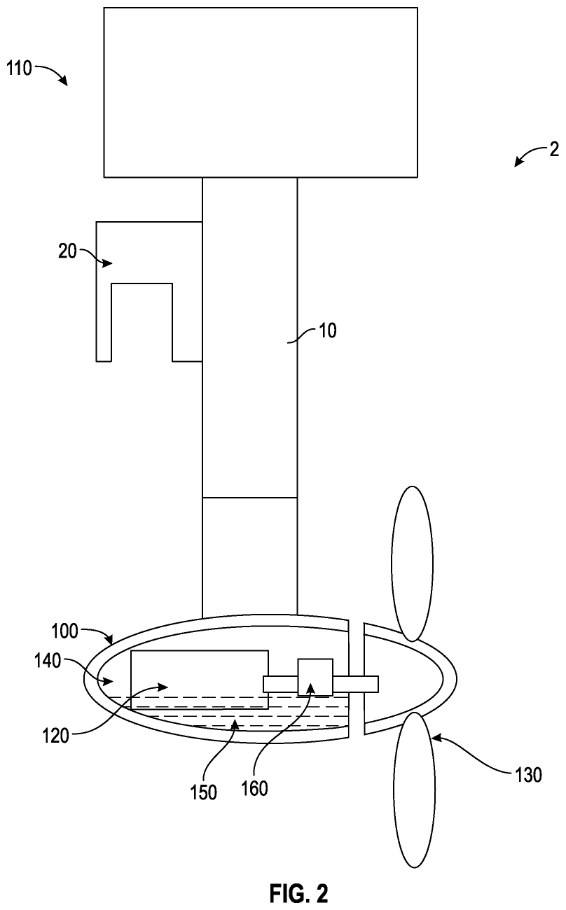

In referring to FIG. 2, an embodiment of an advanced motor cooling system used in connection with a throttling motor 2 is shown. The throttling motor 2 comprises a shaft 10, a bracket 20, an underwater pod 100, and an above-water powerhead 110. The underwater pod 100 comprises a pod chamber 140, which holds a motor 120, a speed gearbox 160, a propeller 130, and cooling liquid 150. The cooling liquid 150 may be a coolant (antifreeze), water, oil, lubricant, or any other suitable liquid. In FIG. 2, the motor 120 and the speed gearbox 160 are partially submerged in the cooling liquid 150. During operation, the cooling liquid 150 facilitates heat exchange between the motor 120/the speed gearbox 160 and the surrounding water. The movements of the speed gearbox 160 or the motor 120 may impart momentum onto the cooling liquid 150, pushing or stirring up the cooling liquid 150 to circulate inside the pod chamber 140.

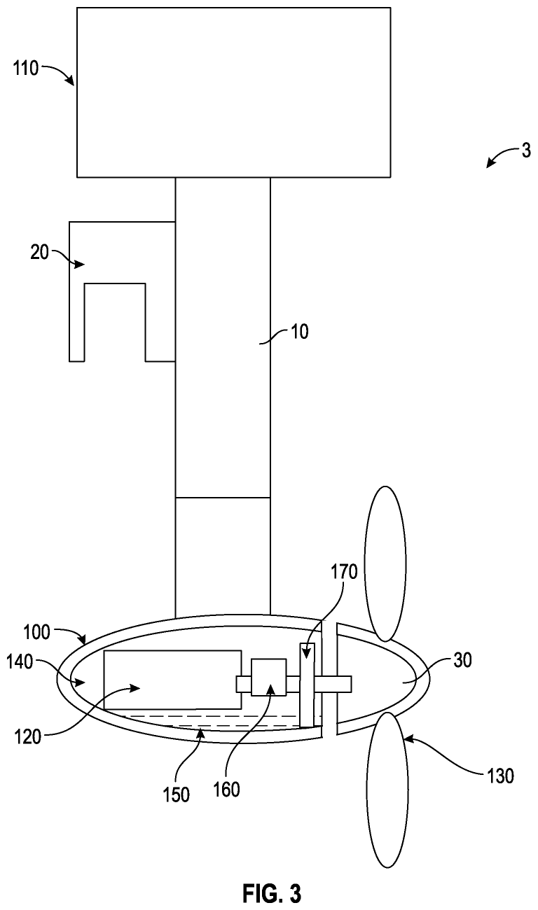

FIG. 3 illustrates another embodiment of an advanced motor cooling system used in connection with a throttling motor 3. Compared to the throttling motor 2, the throttling motor 3 comprises an additional component, a gear pump 170. The gear pump 170 is disposed inside the underwater pod 100, in close proximity to the speed gearbox 160 and the motor 120. The gear pump 170 is configured to receive the cooling liquid 150 through an inlet (not shown in FIG. 3) and pump the cooling liquid 150 over the speed gearbox 160 and/or the motor 120. The gear pump 170 may be an electrical or mechanical pump. Examples of a mechanical pump include orbital pump, plunger pump, gear pump (e.g., cycloid gear pump, gerotor pump, etc.) or vane pump.

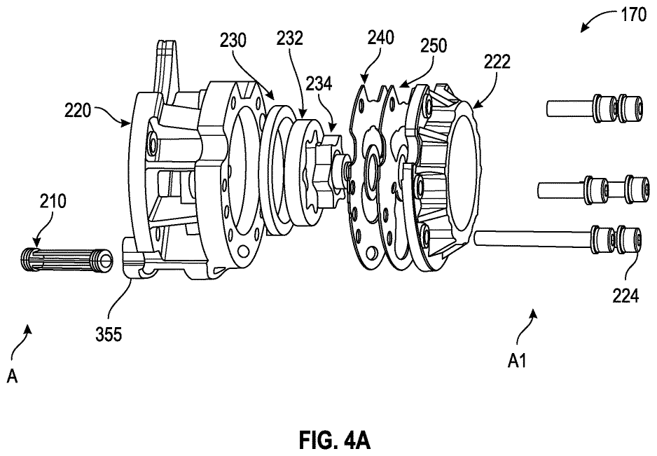

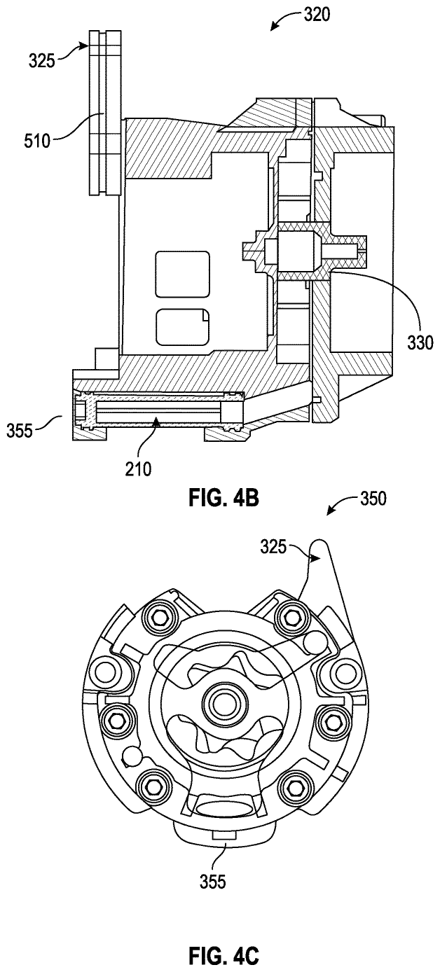

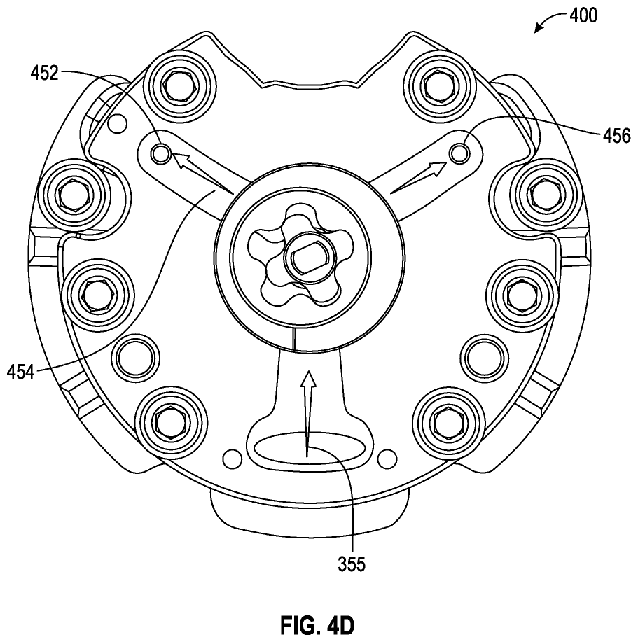

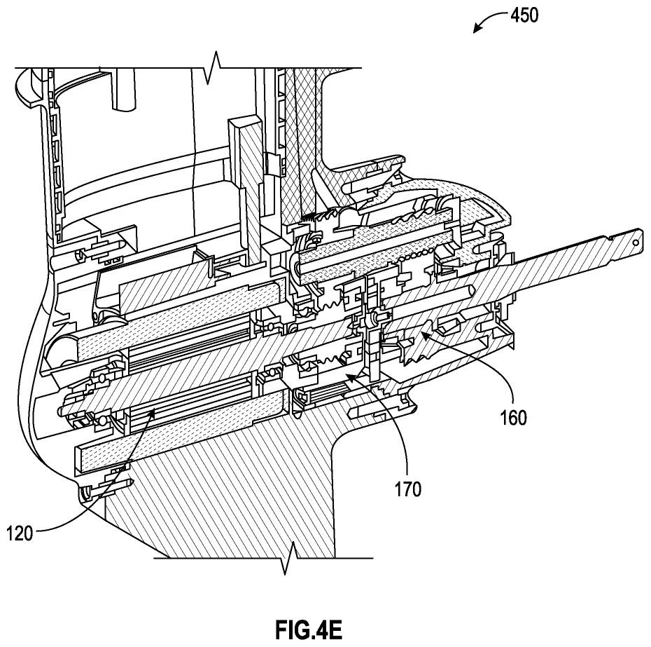

FIG. 4A-FIG. 4D illustrate the inner structure of an example cycloid gear pump 170. A cycloid gear pump is a type of gear pump. A cycloid gear pump typically includes two gears, an inner and outer gear, that are engaged and rotate with each other. The inner gear has one fewer tooth than the outer gear. An example of cycloid gear pumps is a gerotor pump.

FIG. 4A is an exploded view of a cycloid gear pump 170 that includes a lower casing 220 and an upper casing 222. The lower casing 220 and the upper casing 222 are fastened together by three fasteners 224. Enclosed inside the lower casing 220 and the upper casing 222 are a bi-directional gear 230, an outer gear 232, an inner gear plus a shaft 234, a steel washer 240, and a sealing paper washer 250. The cooling liquid 150 enters the gear pump 170 through one or more inlet ports 355 (see FIG. 4B).

In some embodiments, a filter 210 is disposed at one or more of or each of the inlet ports 355 to filter out debris collected from the cooling liquid. The filter 210 may be removably or irremovably coupled to the gear pump 170. The filter 210 may be a suction filter or a press filter. In one embodiment, the filter 210 comprises a magnet to retain metal debris collected from the cooling liquid. 150.

FIG. 4B shows a cross-section view 320 (A-A1) of the gear pump 170. In the embodiment shown in FIG. 4B, the gear pump 170 includes a middle section 330 in between the lower casing 220 and the upper casing 222. The flow path of the cooling liquid 150 is as follows: entering the inlet port 355, passing through the filter 210, moving upwards through the middle section 330. The cooling liquid enters the gear pump 170 through the inlet port 355, passes through the middle section 330, and exiting the gear pump 170 through the outlet port 325 after crossing the lower casing 220. FIG. 4C is a side view 350 of the gear pump 170 in FIG. 4A in the direction of A1 to A. The side view 350 shows the relative position of the inlet port 355 and the outlet port 325. The cooling liquid 150 enters the gear pump 170 through the inlet port 355 at the bottom and goes through the middle section 330 and is pumped out of the gear pump 170 through the outlet port 325 at the top.

FIG. 4D is another side view 400 of the gear pump 170 in FIG. 4A in the direction of A1 to A showing a different embodiment. The embodiment of the gear pump in FIG. 4D shows three outlet ports, 452, 454, and 456, which output the cooling liquid after it is received from the inlet port 355 and is pushed through the middle section 330 inside the gear pump 170.

FIG. 4E is a cross-section view 450 of the underwater pod 100. FIG. 4E illustrates a relative position of the gear pump 170 within the underwater pod 100 in one embodiment of the throttling motor 3. The gear pump 170 is disposed in between the motor 120 and the speed gearbox 160. After the cooling liquid is pumped out of the outlet port or ports of the gear pump 170, the cooling liquid is directed towards the speed gearbox 160 and/or the motor 120.

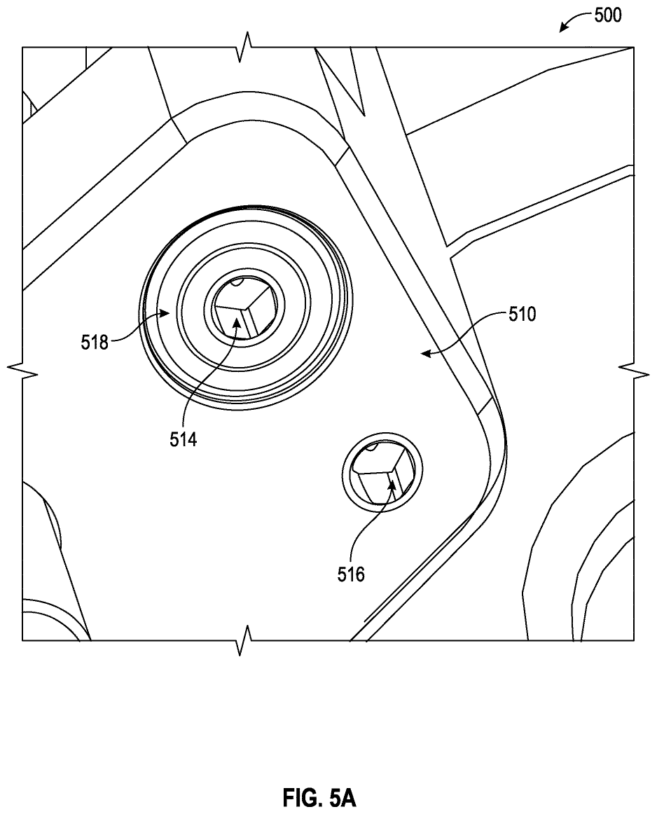

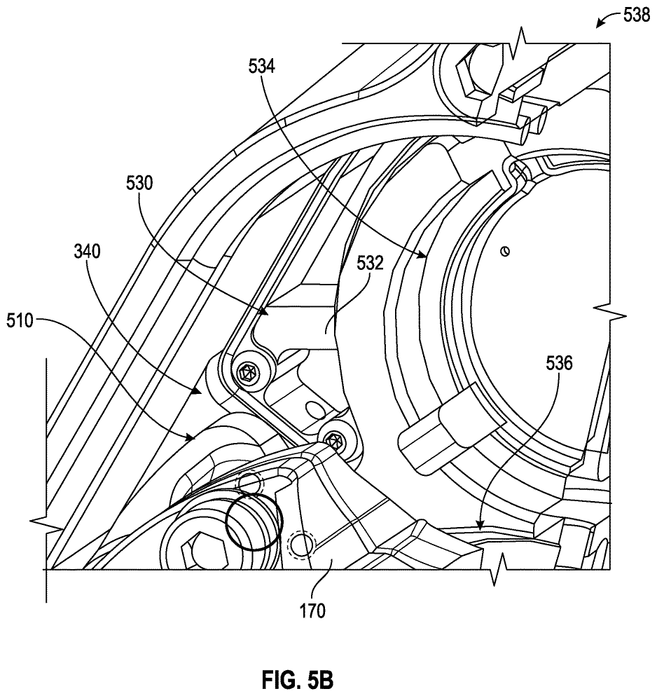

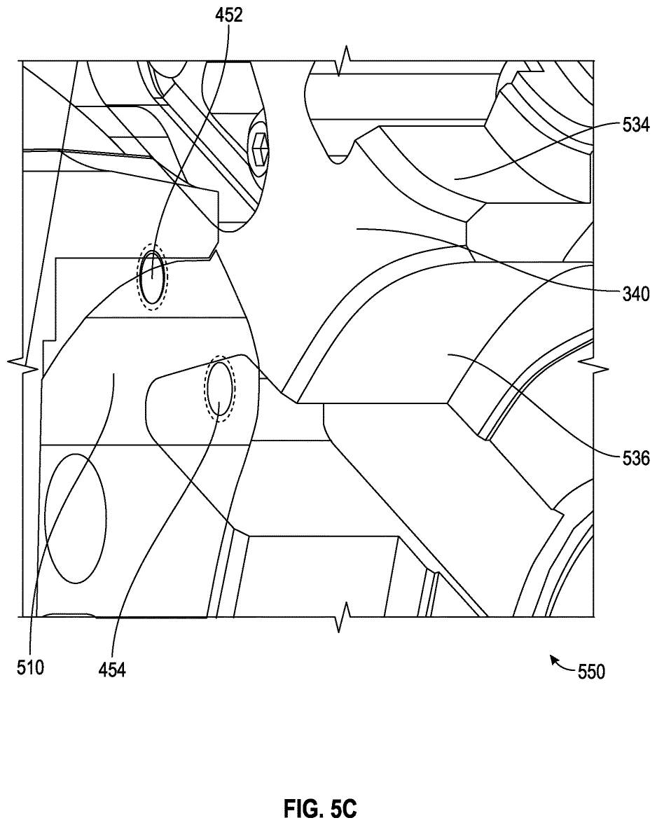

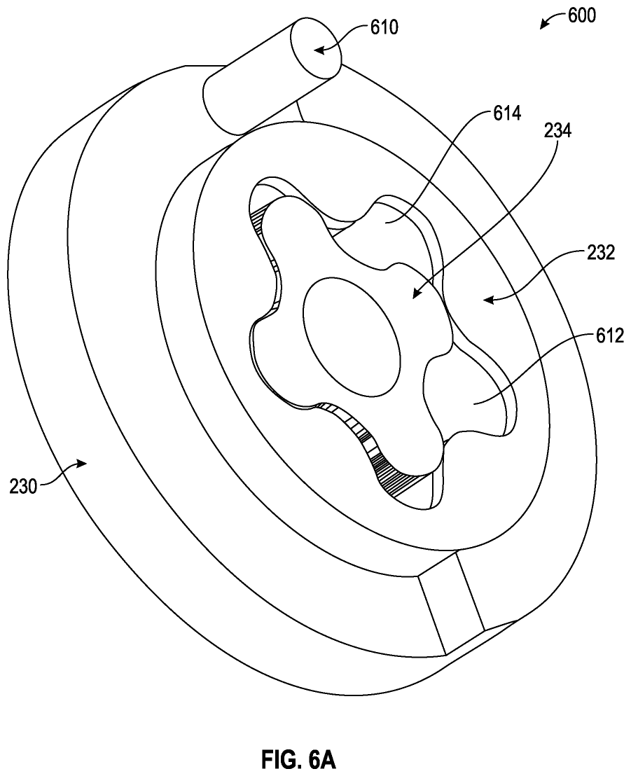

The purpose of directing the cooling liquid towards the speed gearbox 160 and/or the motor 120 may be multifold. A primary use of the cooling liquid is to control or adjust the temperature of the speed gearbox 160 and/or the motor 120. The cooling liquid functions as a coolant. For example, the cooling liquid is in fluid communication with the electric motor or the speed gearbox to provide thermal dissipation and lubrication. The cooling liquid can also function as a lubricant to lubricate the internal mechanical parts inside the speed gearbox 160 and the motor 120. FIG. 5A-FIG. 5D show the coupling between the gear pump 170 and the speed gearbox 160 and the coupling between the gear pump 170 and the motor 120.

When the cooling liquid flows out of the gear pump 170 and into the speed gearbox 160 and the motor 120, the flow rate can be controlled by valves disposed along the flow path. FIG. 5A illustrates a cam plate 510 coupled to the outlet port 325 (behind the cam plate 501, not shown). The cam plate 510 is configured with one or more orifices. An O-ring 518 is fitted around each orifice and a valve, a first valve 514 or a second valve 516, is fitted inside the O-ring 518. The valve, 514 or 516, may be a throttle valve or a magnetic valve. The valves 514 and 516 control the flow rate of the cooling liquid out of the gear pump 170 as shown in FIG. 5B.

In some embodiments, the gear pump 170 is located inside a middle casing that is disposed in between the motor 120 and the speed gearbox 160. In FIG. 5B, the cam plate 510 is disposed in between the gear pump 170 and the middle casing 340. FIG. 5B shows a gearbox shaft 538 inside the middle casing 340. The middle casing 340 includes a storage bin 530 for storing the cooling liquid that flows out of the gear pump 170. The storage bin 530 is covered by a steel cover 532. The cooling liquid flows into the speed gearbox 160 through shaft holes. FIG. 5B shows an upper shaft hole 534 and a lower shaft hole 536, both configured to allow the cooling liquid to reach the shaft and the inside of the speed gearbox 160. The two shaft holes 534 and 536 are mere examples. More or fewer shaft holes can be configured at the same or different positions as shown in FIG. 5B.

FIG. 5C illustrates the coupling between the cam plate 510 and the middle casing 340 from a different angle than shown in FIG. 5B. In FIG. 5C, the cam plate 510 (transparent to show internal structure) is configured with two outlets, a first outlet port 452 and a second outlet port 454. The cooling liquid that flows through the second outlet port 454 is directed to the lower shaft hole 536. Whilst the cooling liquid that flows through the first outlet port 452 is directed to the upper shaft hole 534 with the flow path hidden in the figure.

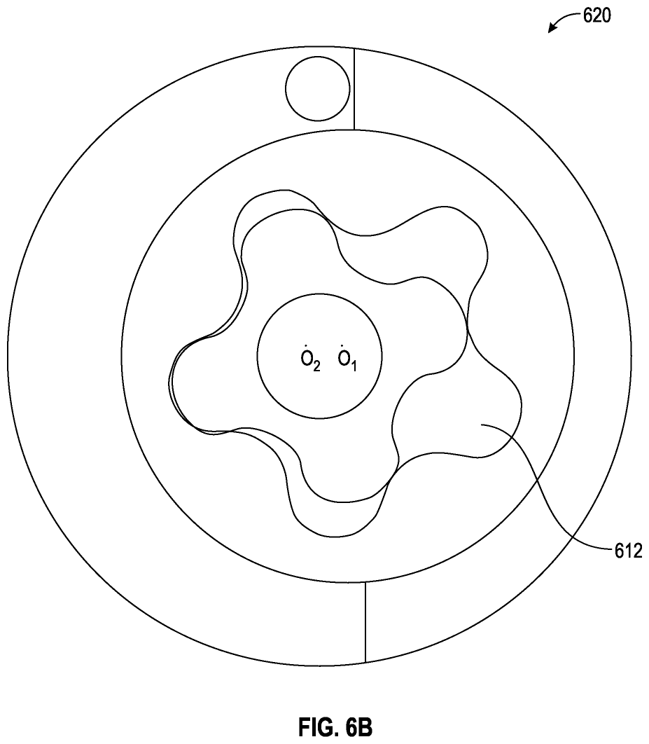

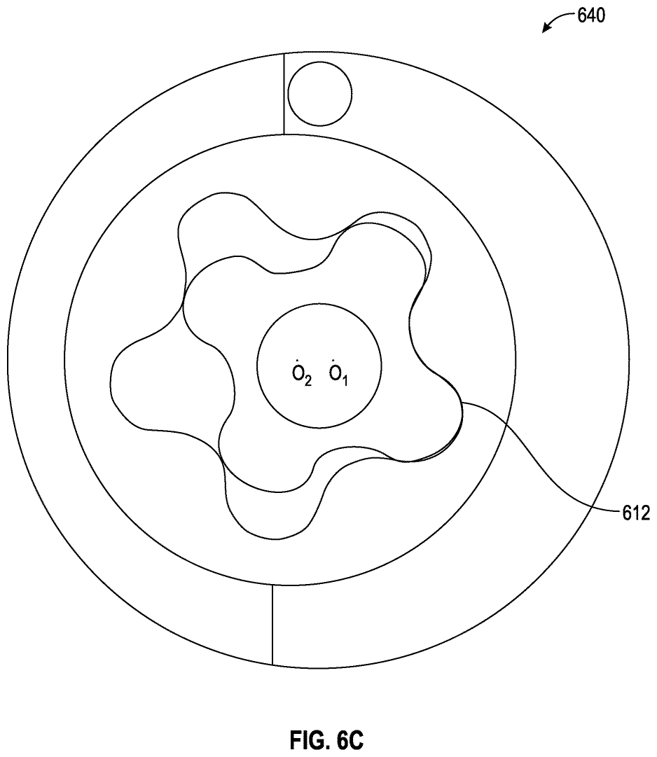

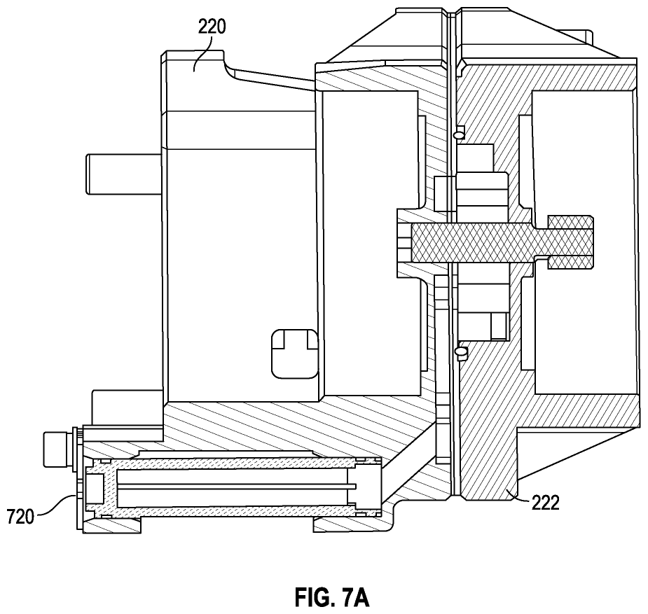

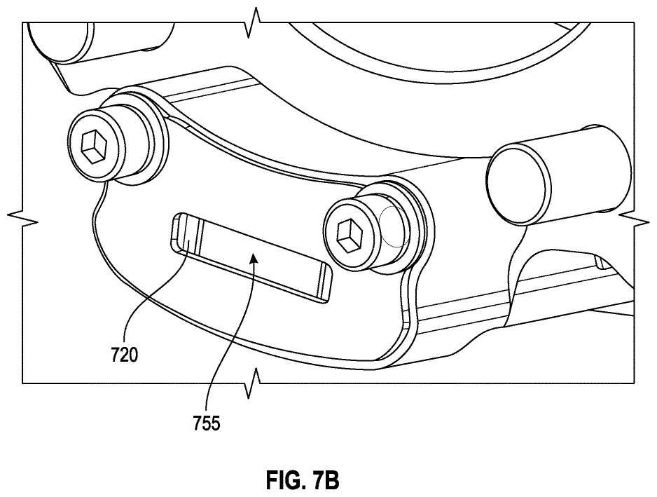

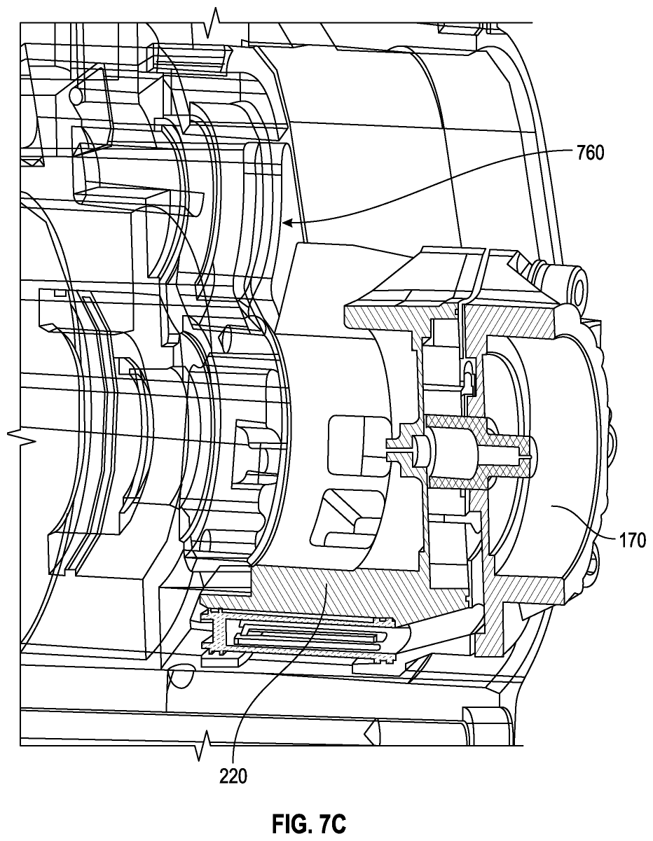

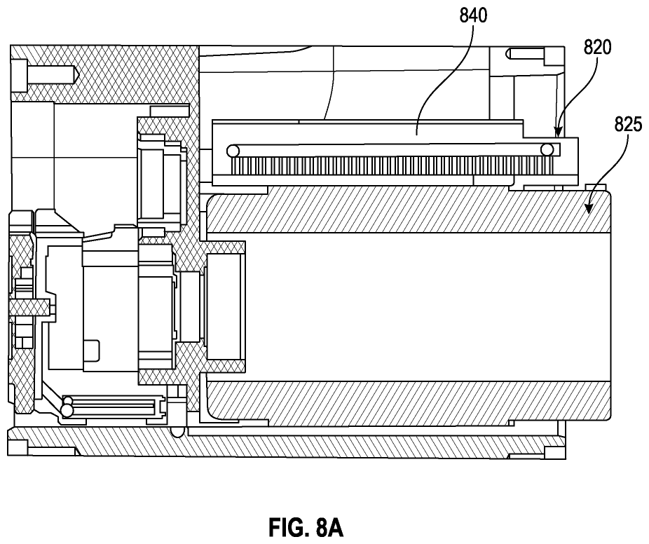

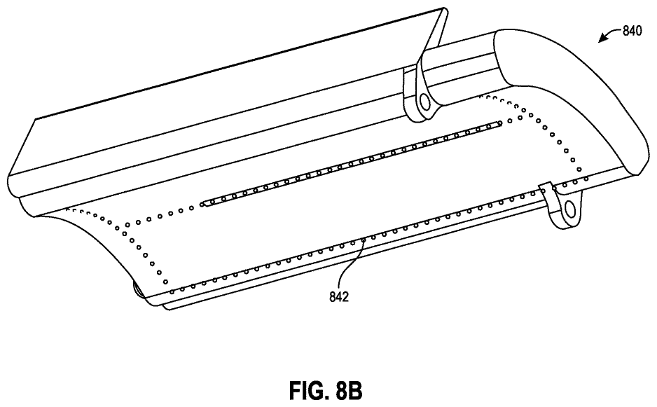

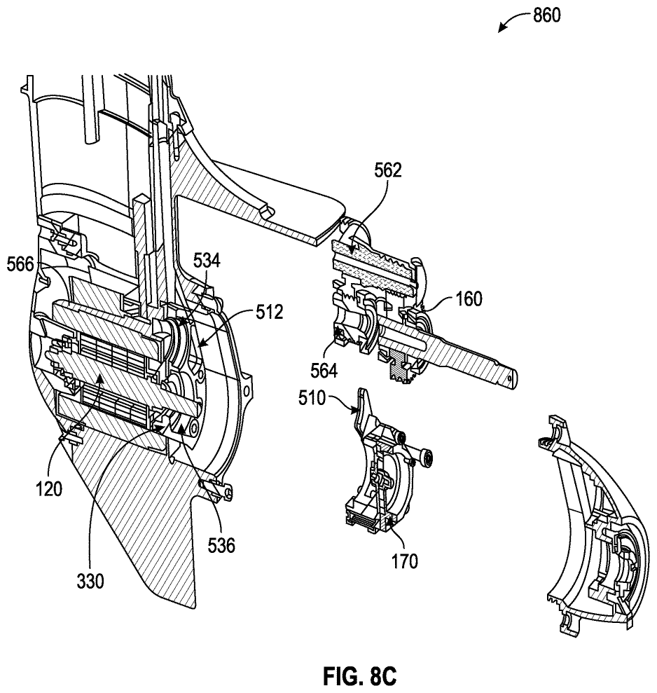

The gear pump 170 draws up the cooling liquid from the bottom of the underwater pod 100 and pumps it to the speed gearbox 160 and/or the motor 120 (see FIG. 3). The cooling liquid is directed towards the speed gearbox 160 via the outlet ports, 452, 454, etc., coupled to the cam plate 510. The cooling liquid may be further directed to the motor 120 via a liquid distributor 840 (see FIGS. 8B and 8D). The gear pump 170 can be implemented as a cycloid gear pump, a gerotor pump, a plunger pump, a vane pump, etc., which are not limited in this disclosure. FIG. 6A-FIG. 7C illustrate a working principle of a gerotor pump 600.

FIG. 6A illustrates the inner portion of the gear pump 170 of FIG. 4A. The bi-directional gear 230 is shown to include a dowel pin 610 used for connection. The bi-directional gear 230 receives the outer gear 232 and the inner gear 234, which are disposed in the center of the gear 230. The inner gear 234 is inserted in and meshed with the outer gear 232. The outer gear 232 includes five (5) teeth and the inner gear 234 includes four (4) teeth. The outer and inner gears differ by one tooth. The outer gear 232 and the inner gear 234 form four sealed space, a first sealed space 612, a second sealed space 614, etc., in between them. The outer gear 232 and the inner gear 234 rotate around two centers, O1 and O2 (shown in FIG. 6B), that are spaced apart by a short distance. In FIG. 6B, the outer gear 232 and the inner gear 234 form a large vacuum in the first sealed space 612. Because of the low pressure in the vacuum, the cooling liquid is sucked into the first sealed space 612 from the underwater pod 100 through an inlet port 355. As the two gears continue to rotate, the volume of the first sealed space 612 gradually decreases and the cooling liquid is pushed out through an outlet port 325. When one tooth of the inner gear 234 is engaged with a tooth concave of the outer gear 232 (see FIG. 6C), the cooling liquid in the first sealed space 612 is completely discharged. As the outer gear 232 and the inner gear 234 continues to rotate, the first sealed space 612 gradually increases, creating a low-pressure space that draws in fresh cooling liquid.

FIG. 7A-FIG. 7C illustrate various configurations in different embodiments of the gear pump 170. FIG. 7A shows a gear pump 170 without a middle section. The gears (bi-directional gear 230, outer gear 232 and inner gear 234) are coupled with the lower casing 220 and the upper casing 222. The cooling liquid flows in through the inlet port 720 and is pumped out through the outlet port configured on the upper casing 222 (not shown). In some embodiments, the inlet port 720 may include magnets 755 to filter out metal debris of the cooling liquid as shown in FIG. 7B. Metal debris in the cooling liquid may cause short-circuit in electrical parts and components, therefore it is important to remove metal debris from the cooling liquid before the cooling liquid is diverted to the motor 120 or other electronic devices. The inlet port 720 may further include other types of filters to keep the cooling liquid clean and free of impurities and dirt. In some embodiments, the cam plate 510 is inserted into a groove of the lower casing 220. Along the groove, seals 760 (FIG. 7C) such as silica glue is used to seal and affix the cam plate 510.

FIG. 5B illustrates the cooling liquid being directed into the speed gearbox 160. In some embodiments, the cooling liquid functions as a coolant to prevent the speed gearbox 160 from overheating during operation. In some embodiments, the cooling liquid also functions as a lubricant oil to lubricate the mechanical parts of the speed gearbox 160, for example, the shafts and bearings. In some embodiments, the cooling liquid can be directed into the motor 120 as coolant as well as lubricant. FIG. 8A and FIG. 8B illustrate a liquid distributor for distributing the cooling liquid over the motor 120.

FIG. 8A is a cross-sectional view of the gear pump 170 fluidly coupled to a liquid distributor 840. The liquid distributor 840 is coupled to the gear pump 170, via an outlet port such as 452, 454, or 456 of the gear pump 170. The cooling liquid flows out of the gear pump 170 and is fed into a liquid distributor 840. The motor 120 is represented by the rotor 825. In the liquid distributor 840, a tube 820 runs lengthwise. The tube 820 may be made of resin or other suitable materials suitable for the working condition of the underwater pod 100. An array of orifices (842 in FIG. 8B) is configured on the side of the tube 820 that faces the rotor 825. When the cooling liquid is pushed along the tube 820, it is discharged through the orifices and drips onto the rotor 825. When the cooling liquid contacts the exterior surfaces of the rotor 825, the cooling liquid absorbs heat energy from the rotor 825 and cools down the temperature of the rotor 825. The cooling liquid functions as a coolant by absorbing thermal energy from the rotor 825. In some embodiments, the cooling liquid may be a type of oil suitable to be used as a lubricant. A small amount of the cooling liquid may be diverted from the usual flow path. The diverted cooling liquid seeps through certain shaft holes configured on the surface of the rotor 825 and is distributed to the machine parts of the motor 120 for lubrication.

FIG. 8C is a partially exploded cross-sectional view 860 of an integrated motor cooling system 30 disclosed herein. In FIG. 8C, the motor 120 is depicted on the right side of the figure. The speed gearbox 160 is on the upper right side of the figure and the gear pump 170 is on the lower right side of the figure. The motor 120 is coupled to the middle section 330. A resin liquid distributor 566 is configured to distribute cooling liquid over the motor 120. In one embodiment, the cooling liquid is spread over the motor 120 through orifices in the distributor 566 like a shower head. The speed gearbox 160 comprises an upper shaft 562 and a lower shaft 564. The cooling liquid pumped by the gear pump 170 comes through the outlet ports, e.g., the first outlet port 452 and the third outlet port 456 (see FIG. 4D) on or coupled to the cam plate and flows into the upper shaft hole 534 and the lower shaft hole 536 to reach the upper shaft 562 and the lower shaft 564 of the speed gearbox 160. The cam plate 510 of the gear pump 170, used as a connection between the gear pump 170 and the speed gearbox 160, is inserted into the cam plate groove 512. Around the cam plate groove 512 a seal can be placed to prevent leaking.

Embodiments of the motor cooling system 30 described above show the motor cooling system 30 being used in an underwater pod 100 beneath a vessel. During operation, the cooling liquid is pumped by the gear pump 170 and is spread over the speed gearbox and/or motor of the vessel engine. The cooling liquid absorbs the thermal energy from the vessel engine when it is in contact with the exterior and/or interior surfaces of the various parts in the engine. When the cooling liquid returns to the liquid reservoir at the bottom of the underwater pod 100, its temperature has risen because of the thermal energy absorbed from the running engine. The returned cooling liquid raises the temperature of the cooling liquid in the reservoir, for example, the bottom of the underwater pod 100. Through the shell of the underwater pod 100, the cooling liquid dispels the heat into the surrounding water. This thermal cycle effectively cools the vessel engine when it is running, to prevent the engine from overheating.

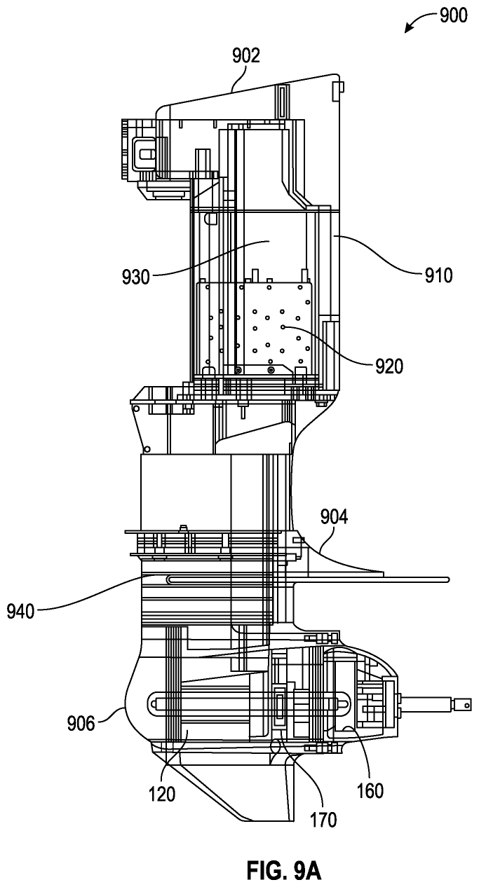

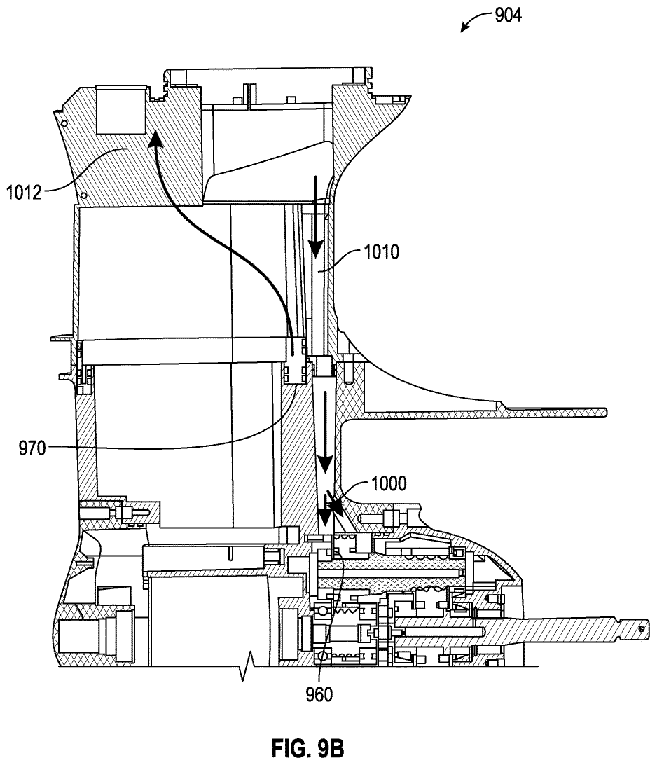

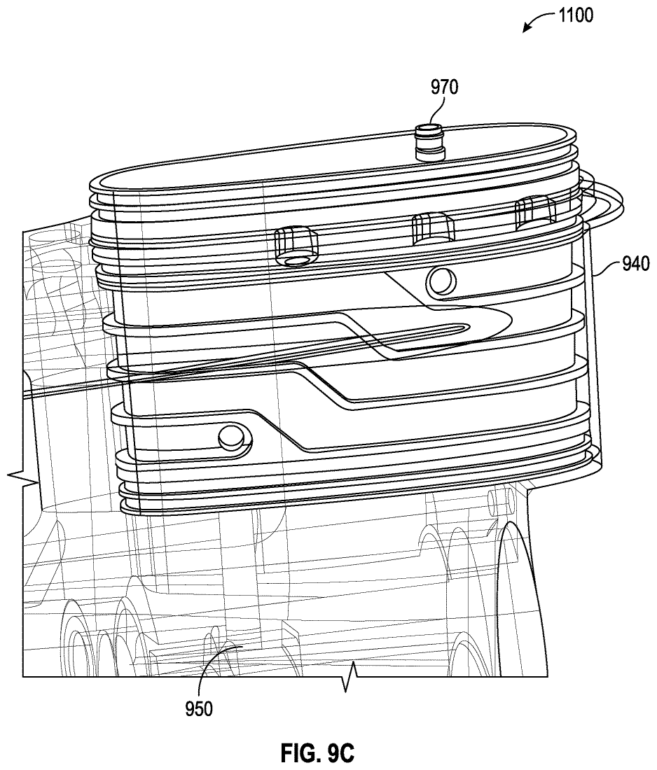

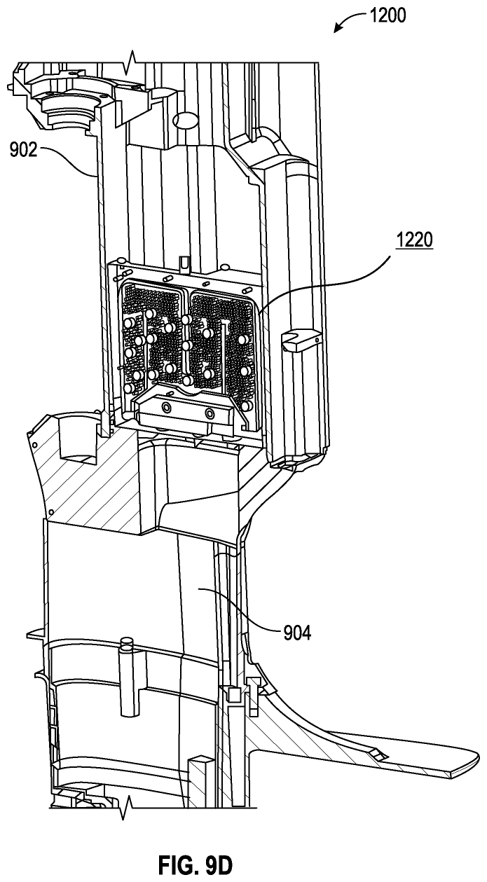

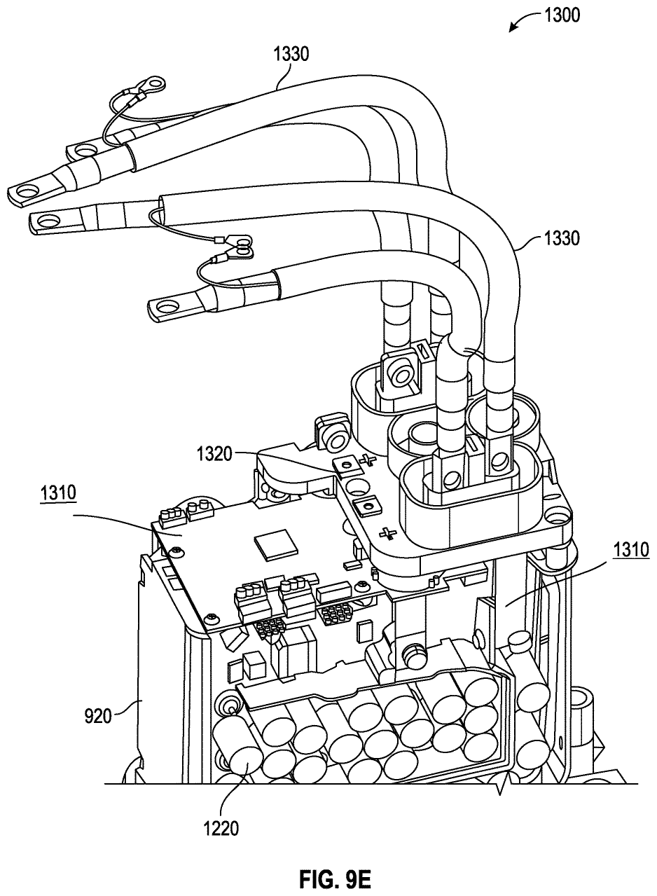

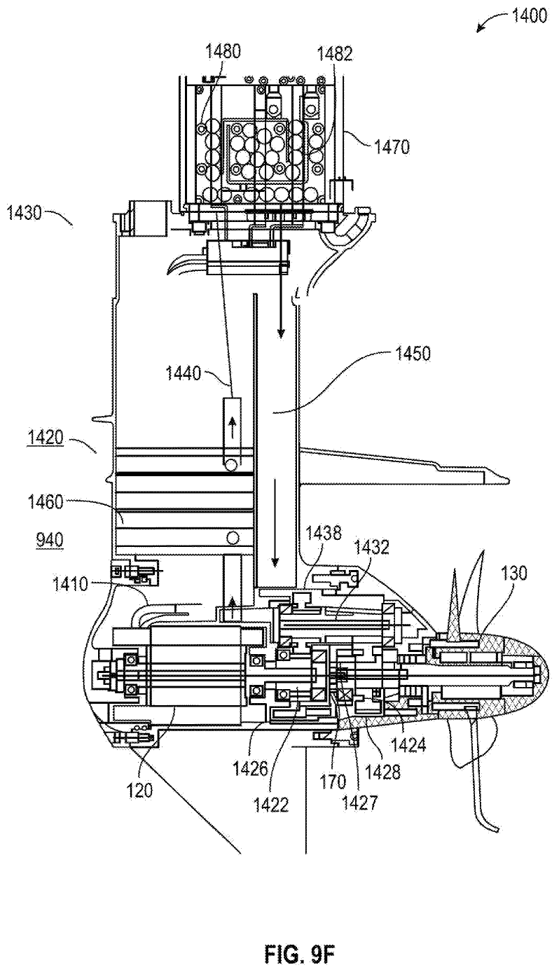

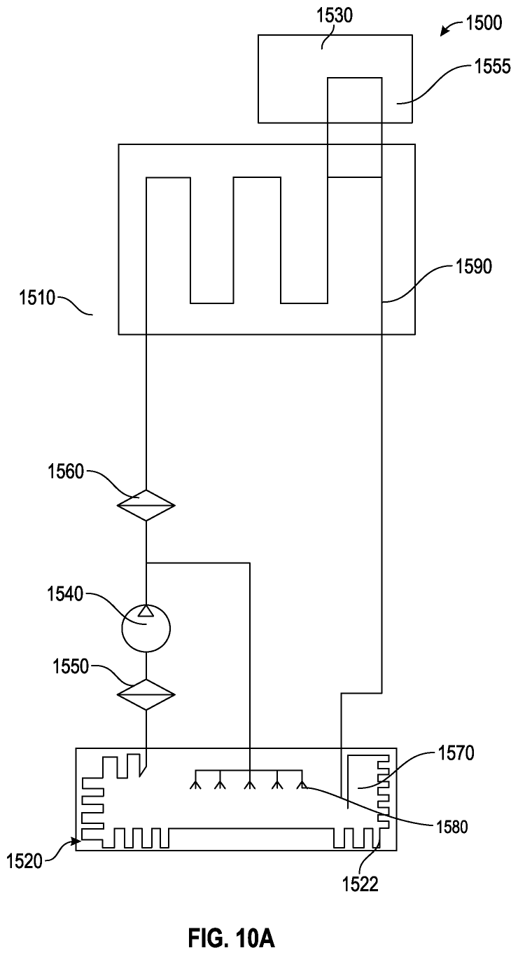

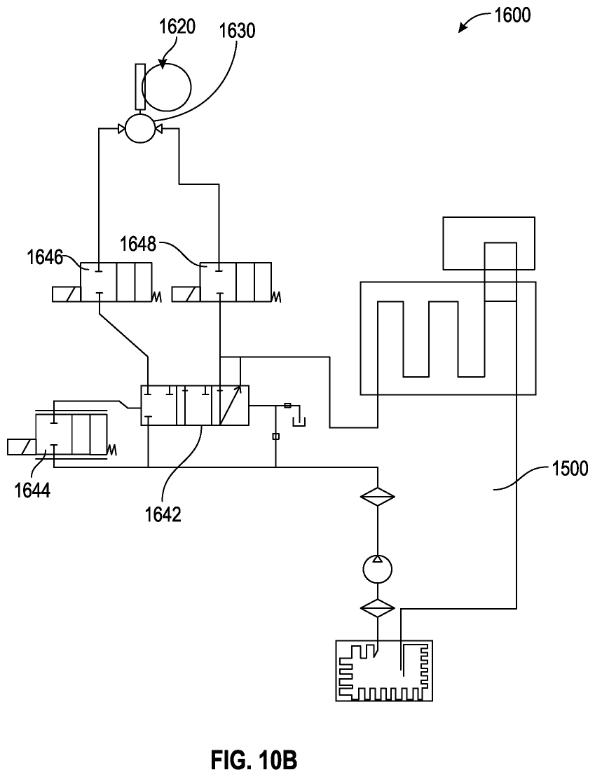

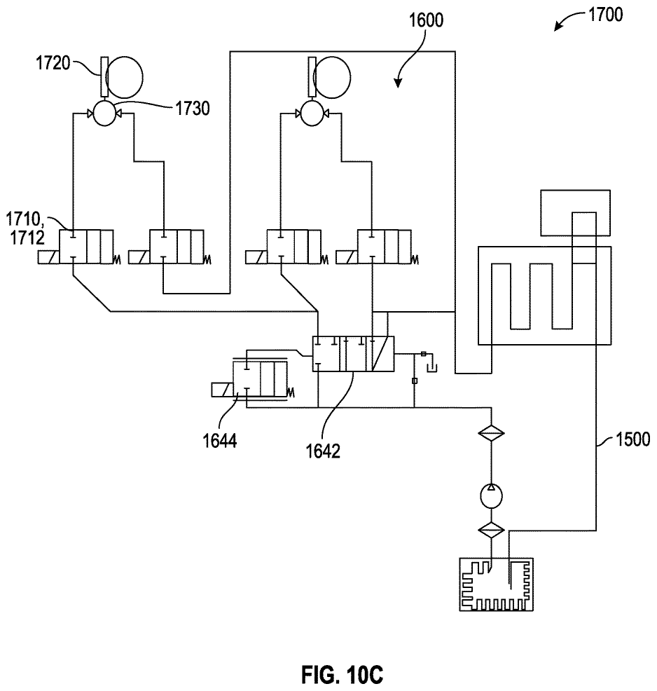

In the embodiments described above, the motor cooling system 30 circulates the cooling liquid inside the underwater pod 100 and relies on the surrounding water to absorb the thermal energy generated by the engine for cooling during circulation. In the embodiments illustrated in FIGS. 9A-10D, the motor cooling system 30 may include one or more cooling devices to cool down the cooling liquid before returning the cooling liquid to the reservoir in the underwater pod 100. In some embodiments, an expanded motor cooling system 30 may circulate the cooling liquid to different parts of the vessel for cooling or temperature control.

FIG. 9A illustrates an embodiment of an expanded motor cooling system 30. In FIG. 9A, an outboard motor 900 is divided into three sections, the top section 902, the middle section 904, and the lower section 906. The top section includes an above-water powerhead 910, which comprises a electronic control bay 930 for housing control electronics and an electric cooling plate 920. The middle section 904 is a casing designed to connect the top section 902 and the lower section 906. The middle section 904 may include a bracket 20 (not shown) that attaches the outboard motor 900 to the transom of the boat or vessel. The middle section 904 functions as a housing of a driveshaft and electronic cables. The middle section 904 also houses water tubes (1000 in FIG. 9B) that transport the cooling liquid between the top section 902 and the lower section 906. As an example, the arrows indicate the general flow direction of the cooling liquid. However, in actual implementations, the flow path of the cooling liquid may be different. For example, the water tubes 1000 are arranged around mechanical parts or other components.

In some embodiments, the middle section 904 includes a cooling coil 940. The cooling coil 940 is disposed inside the casing. In one embodiment, the cooling coil 940 is arranged close or attached to the inner surface of the casing. The cooling coil 940 wraps around the other parts housed in the middle section 904. The cooling coil 940 is connected to the water tubes 1000 at one end and to an outlet port on the lower portion of the motor cooling system 30 at the other end. The lower portion of the motor cooling system 30 is located inside the lower section 906. In some embodiments, the lower section 906 is the underwater pod 100 described in FIG. 3. As shown in FIG. 9A, the lower section 906 includes a speed gearbox 160 and a motor 120. The lower section 906 includes a gear pump 170 that is disposed in between the speed gearbox 160 and the motor 120. The gear pump 170 is configured with an outlet port 325 for the cooling liquid to flow out. The outlet port 325 may be connected to a storage bin 530 (see FIG. 5B). The storage bin 530 is configured to supply cooling liquid to the speed gearbox 160. In some embodiments, the storage bin 530 may be further configured to supply cooling liquid to the cooling coil 940 via an outlet (950 in FIG. 9B and FIG. 9C).

FIG. 9B shows an enlarged view of the flow path of the cooling liquid in the middle section 904 of the outboard motor 900. The arrows show a forward path 1012 and a return path 1010 of the cooling liquid. A water tube 1000 is connected to an inlet 960 on the lower section 906. The inlet 960 may be connected to the gear pump 170 or the storage bin 530. Through the inlet 960, the cooling liquid flows back to the gear pump 170. On the forward path 1012, a port 970 is an interface port functioning as a connection point between two adjacent parts on the forward path 1012. For example, a cooling coil 940 may be installed on the forward path 1012 and be connected to the flow path via the port 970.

FIG. 9C shows an example configuration of the cooling coil 940. One end of the cooling coil is connected to a port 970, which may be connected to a water tube 1000. The other end of the cooling coil 940 is connected to an outlet 950 of the gear pump 170. The outlet 950 may be connected to the outlet port 325 in FIG. 4B or connected to the storage bin 530 in FIG. 5B. The flow direction of the cooling liquid is circling through the cooling coil 940 going upward towards the port 970. The cooling coil 940 wraps around the various parts that are disposed in the middle section 904, e.g., driveshaft, cables, etc. In some embodiments, the cooling coil 940 wraps around a cylindrical structure that houses a driveshaft, cables, gears, etc.

In some embodiments, the cooling coil 940 may be disposed on the casing wall of the middle section 904. The casing wall may be made of a material that is a good thermal conductor, e.g., metal. Similar to the shell of the underwater pod 100, the casing wall facilitates heat exchange between the cooling liquid and the surrounding water. The cooling liquid that flows out the gear pump 170 or the storage bin 530 carries the thermal energy absorbed from the speed gearbox 160 and/or the motor 120. When the cooling liquid flows through the cooling coil 940, the cooling coil 940 provides an enlarged heat exchange surface that allows the thermal energy in the cooling liquid to dissipate into the surrounding water through the casing wall. The underwater pod 100 is a heat exchange surface that facilitates thermal energy dissipation. The cooling coil 940 provides a second heat exchange surface for the cooling liquid to cool down using the surrounding water. The cooling liquid that flows out of the port 970 may be further cooled using electric cooling devices as shown in FIG. 9D. It is noted that an embodiment in which the cooling coil is disposed outside the casing wall is also contemplated.

FIG. 9D illustrates a cooling device 1200 in the shape of a tube bundle 1220. The cooling device 1200 is installed in the bottom part of the top section 902. The tube bundle 1220 comprises a bundle of tubes running widthwise. The tubes are packed in a honey-comb style. The tubes are made of a good thermal conducting material, such as metal. As the cooling liquid passes through the space in between the tubes, the cooling liquid exchanges thermal energy with the surfaces of the tubes. In one embodiment, the cooling liquid that flows through the tube bundle 1220 is supplied by the storage bin 530. In another embodiment, the cooling liquid that flows through the tube bundle 1220 is supplied by the gear pump 170 directly. In yet another embodiment, the cooling liquid that flows through the tube bundle 1220 is supplied by the cooling coil 940.

In some embodiments, the bottom part of the top section 902 may include the tube bundle 1220 and/or an electric cooling plate 920 as shown in FIG. 9A. The tube bundle 1220 may be a stand-alone electric cooling device. The tube bundle 1220 may be a part of the electric cooling plate 920. Driven by electricity, a refrigerant may be cycled between a condenser and evaporator (not shown in the figures). When the condensed refrigerant turns from liquid into gas, for example, inside the tube bundle 1220 and/or the electric cooling plate 920, the evaporation process absorbs energy from the surroundings and cools the area around it, for example, the tubes in the tube bundle 1220 and/or the plate in the electric cooling plate 920. As the cooling liquid passes through the bottom part of the top section 902, it comes into contact with the tubes and/or the electric cooling plate and becomes chilled. In one embodiment, a check valve may be disposed at either an inlet or an outlet of the above-water electronic cooling device, e.g., the tube bundle 1220 or the electric cooling plate 920. The check valve is configured to retain a portion of the cooling liquid inside electronic cooling device when an operation of the motor cooling system 30 is disabled. The retained cooling liquid enables the electronic cooling device to function when the operation of the motor cooling system 30 resumes.

In some embodiments, the cooling liquid, after being chilled by the electric cooling device, for example, the tube bundle 1220 and/or the electric cooling plate 920, may be returned to the gear pump 170 or the reservoir at the bottom of the underwater pod 100. In some embodiments, the cooling liquid is transferred to other parts of the vessel for temperature control. For example, the cooling liquid may be transferred to the above-water powerhead 910, which is often installed at the top of the top section 902 (see FIG. 9A). The above water powerhead 910 may house electronic components and/or engine parts such as an engine block which comprises pistons, cylinders, crankshaft, etc. The powerhead 910 is often configured with channels or passages that are integrated with the engine block to allow the cooling liquid to flow through the powerhead 910 so that the engine does not overheat.

In some embodiments, the above-water powerhead 910 comprises an electronic control bay 930. The electronic control bay 930 houses electronic control devices, for example, the electronic control unit 1310 in FIG. 9E. The electric cooling plate 920 and/or the tube bundle 1220 may be disposed inside the electronic control bay 930. The electric cooling plate 920 and/or the tube bundle 1220 may be also disposed outside the electronic control bay 930, for example, underneath the electronic control bay 930.

In some embodiments, the electronic control bay 930 comprises a dual panel structure. Electronic equipment or device is disposed on an outer surface of each panel in the dual panel structure. The space between the two panels in the dual panel structure accommodates a passage for the cooling liquid to flow through. As the cooling liquid flows through the passage between the two panels, it reduces the temperature of the electronic equipment. FIG. 9E shows two electronic control units 1310 disposed above the tube bundle 1220. In between the two control units 1310, a grounding bar 1320 is built in to ground the electric panel or panels. Two sets of wires 1330 connect the electric panel or panels to a power source such as a battery.

In some embodiments, two identical sets of electronic equipment are disposed on each panel of the dual panel structure respectively. One set of electronic equipment is a mirror system of the other set. This dual electronic system can be configured to implement a failover function. In a mirror system, one set of electronic equipment is the active unit and the other set is a standby unit. When the active unit fails, the standby unit takes over. That is, during a failure of the electronic equipment, the functionalities that were handled by the failed unit are turned over to the standby unit.

In some embodiments, two sets of electronic equipment are disposed on each panel of the dual panel structure, each connected to a rotor in a dual-rotor motor. A dual-rotor motor provides more horsepower than a single-rotor motor.

The above-water electronic control bay 930 may be encased in a thermal silica cover. The thermal silica cover protects the above-water electronic control bay 930 from the cooling liquid. The thermal silica cover also absorbs thermal energy from the above-water electronic control bay 930. The absorbed thermal energy is then dissipated into the cooling liquid through the thermal silica cover. The thermal silica cover may be configured with an air duct that is fluidly connected to an air pressure pump to control air pressure within the above-water electronic control bay 930. Another solution to control or adjust the air pressure inside the above-water electronic control bay 930 is by using an air piston. Also, a rubber tube may be used to connect the above-water electronic cooling device 1200 with the cooling coil 940. The rubber tube can expand or contract when air pressure inside the above-water electronic control bay 930 fluctuates.

FIG. 9F is a block diagram illustrating another embodiment of an expanded motor cooling system 30 in an outboard motor 1400. The outboard motor 1400 can be sectioned into a lower section 1410, a middle section 1420, and a top section 1430. The lower section 1410 includes a motor 120, a mechanical orbital pump 170, a speed gearbox 160, and a propeller 130. The three-phase motor 120 drives an input shaft gear 1422. The input shaft gear 1422 transfers the power from the motor to an output shaft gear 1424 that drives the speed gearbox 160. The output shaft gear 1424 runs at different speeds depending on the gear ratio, which drives the propeller at different rates.

The mechanical orbital pump 170 is situated in between the motor 120 and the speed gearbox 160. The shaft 1427 of the pump is aligned with the input shaft and the output shaft. In some embodiments, the speed gearbox 160 may also include an intermediate shaft 1432. The gear pump 170 takes in the cooling liquid through an inlet port 1426. A filter is disposed inside the inlet port 1426 to filter out debris in the cooling liquid. The cooling liquid is transferred by the gear pump 170 to one or more cooling regions. The one or more cooling regions include a gearbox cooling region 1428 and a stirrup cooling region 1438. The gearbox cooling region 1428 includes the input shaft and the output shaft. The cooling liquid transferred to the gearbox cooling region 1428 can effectively cool down the input and output shaft. The stirrup cooling region 1438 includes the intermediate shaft 1432 and the cooling liquid transferred to the stirrup cooling region 1438 can effectively cool down the intermediate shaft 1432.

In the expanded motor cooling system 30 of FIG. 9F, the cooling liquid is pumped upwards into the middle section 1420 and the top section 1430. The expanded motor cooling system 30 may include a primary pump (e.g., the gear pump 170) and optionally a secondary pump (not shown) that is configured to pump the cooling liquid through the cooling coil into the top section 1430. The forward path 1440 shows the passage in which the cooling liquid leaves the lower section 1410 and travels towards the middle and top sections 1420 and 1430. In some embodiments, the forward path 1440 is defined by a rubber tube. The return path 1450 shows the passage in which the cooling liquid travels back to the lower section 1410. Because rubber is elastic and can expand or contract as the inside air pressure changes, using a rubber tube as a conduit of the cooling liquid can effectively adjust the air pressure inside the sealed or passage of the cooling liquid.

In FIG. 9F, a cooling coil 1460 is installed on the forward path 1440. When the cooling liquid passes through the cooling coil 1460, the cooling coil 1460 functions as a heat exchanger that allows the cooling liquid to dispel heat into the surrounding water. After leaving the cooling coil 1460, the cooling liquid enters the top section 1430. The top section 1430 includes an overboard powerhead 1470 that houses various electronic devices and control boards. The top section 1430 also includes one or more electric cooling plates 1480 and/or cooling devices such as a tube bundle 1482 described above. Along the forwarding path 1440, the cooling liquid leaves the cooling coil 1460 and enters the top section 1430. The cooling liquid is further “chilled” by the electric cooling plate 1480 and/or the tube bundle 1482 before entering the electronic control bay 930 through a defined channel or passage. By absorbing the heat generated by the electronics in the electronic control bay 930, the cooling liquid keeps the electronic control bay 930 from overheating. After leaving the electronic control bay 930, the cooling liquid returns to the lower section 1410 via the return path 1450.

The motor cooling system 30 described above is improved over prior art motor cooling systems. The motor cooling system 30 is more efficient in heat dissipation than the prior art systems. The motor cooling system 30 is more compact and occupies less space than prior art systems. The principles and concepts of the innovative motor cooling system disclosed herein however are not limited to the embodiments described herein. Variations and expansions of the principles and concepts disclosed herein are within the protective scope of the present disclosure. FIG. 10A-FIG. 10C are block diagrams illustrating several example embodiments of the motor cooling system 30 based on the principles and concepts taught herein.

FIG. 10A illustrates an embodiment of a motor cooling system 1500 in which the gear pump is disposed outside the underwater pod. The motor cooling system 1500 includes a circulation route 1510, which goes through the underwater pod 1520 and the outboard powerhead 1530. The underwater pod 1520 houses a speed gearbox 1570, among other machine parts that are not shown. A liquid distributor 1580 is disposed above the speed gearbox 1570 and other machine parts that are not shown. The liquid distributor distributes, e.g., drips or sprays, cooling liquid onto the shaft or shafts of the speed gearbox 1570 to allow it to operate at its optimum operating temperature. The cooling liquid is collected on the bottom surface of the underwater pod 1520. The shell of the underwater pod 1520 is a good thermal conductor and facilitates heat exchange between the cooling liquid and the surrounding medium, e.g., air or water. The cooling liquid collected on the bottom surface of the underwater pod 1520 is drawn up by the pump 1540. The pump 1540 may be mechanical or electrical. The cooling liquid passes through a filter 1550 before entering the pump 1540 so that debris in the cooling liquid are taken out of the cooling liquid before entering the circulation route 1510. The pump 1540 outputs the clean cooling liquid into a cooling coil 1560 through which the cooling liquid to continue to dispel heat into the surrounding medium. After the cooling coil 1560, the cooling liquid goes through one or more electric cooling plates 1590 and/or other cooling devices (not shown) before entering the outboard powerhead 1530. The electric cooling plates 1590 further “chills” the cooling liquid before the cooling liquid enters the outboard powerhead 1530 for temperature control and overheating prevention. The motor cooling system 30 further includes a by-pass ultra-fine filter 1555 that is configured to filter out finer particles and debris that may have escaped the filter 1550 and/or to filter out debris that may have emerged after the filter 1550. The by-pass ultra-fine filter may be configured to filter out metal debris that are prone to cause short circuit in electronic devices. After the outboard powerhead 1530, the cooling liquid returns to the underwater pod 1520. The cooling liquid may enter a pathway or channel defined or affixed on the shell of the underwater pod 1520. The shell of the underwater pod 1520 being a good thermal conductor allows the thermal energy absorbed in the returned cooling liquid to dissipate into the surrounding water.

FIG. 10B illustrates an integrated system 1600 comprising the motor cooling system 1500, a steering worm gear 1620, and a steering motor 1630. The motor cooling system 1500 supplies cooling liquid to the steering worm gear 1620 and the steering motor 1630 for cooling. To control the flow of the cooling liquid, several valves are installed to adjust the flow rate of the cooling liquid. The valves can also shut off the cooling liquid if desired. Between the motor cooling system 1500 and the rest of the integrated system 1600, a main valve 1642 is installed to control the flow of the cooling liquid into the other parts of the integrated motor system 1600. A pilot valve 1644 may also be used to control the flow of the cooling liquid into the steering system. Circulation valves 1646 and 1648 are used to control the flow of the cooling liquid into the steering motor 1630 and the steering worm gear 1620 respectively.

FIG. 10C illustrates another integrated motor system 1700 that comprises two steering systems and the motor cooling system 1500. In FIG. 10C, a second steering worm gear 1720 and a second steering motor 1730 are added, as compared to FIG. 10B. Two circulations valves 1710 and 1712 are used to control the flow of the cooling liquid into the second steering system. The motor cooling system 1500 is configured to supply cooling liquid to both steering systems. The main valve 1642 and the pilot valve 1644 are installed between the motor cooling system 1500 and the steering systems for flow control.

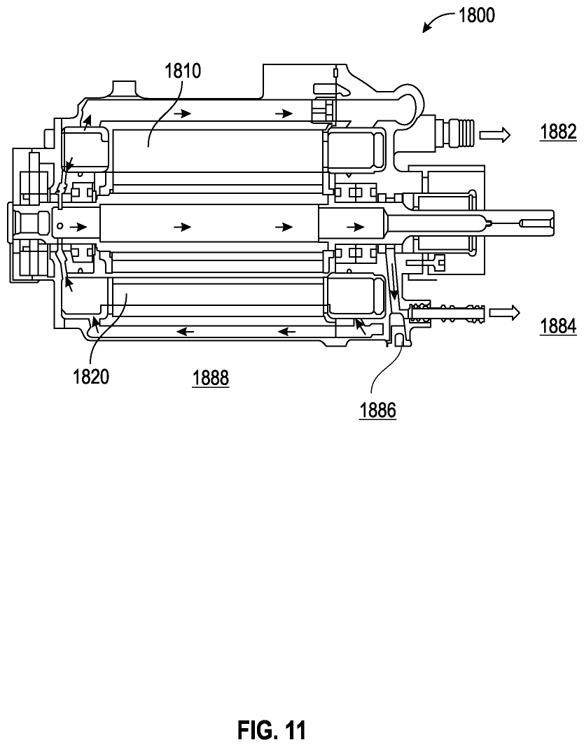

FIG. 11 illustrates an embodiment in which the cooling liquid is piped into the electric motor 1800. As shown in FIG. 11, the motor 1880 includes a stator 1810 and a rotor 1820. The arrows show the pathway the cooling liquid flows through the motor. The cooling liquid flows into the motor through the inlet 1886 and follows the pathway as shown by the arrows. The cooling liquid flows out the motor through the stator outlet 1882 and rotor outlet 1884. To protect the mechanical parts of the motor from the cooling liquid, a seal tube 1888 is used to cover the stator and the rotor so the cooling liquid does not come into contact with the mechanical parts even when the cooling liquid is leaked from its normal pathway, preventing corrosion and damage caused by leakage.

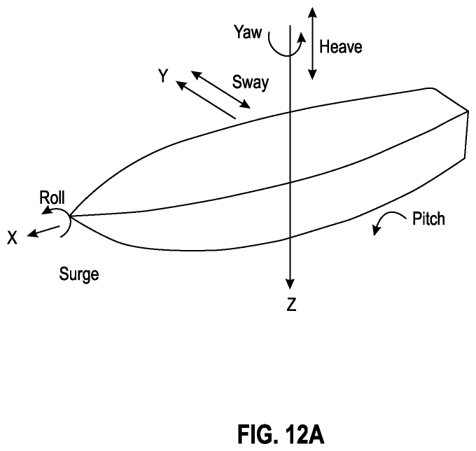

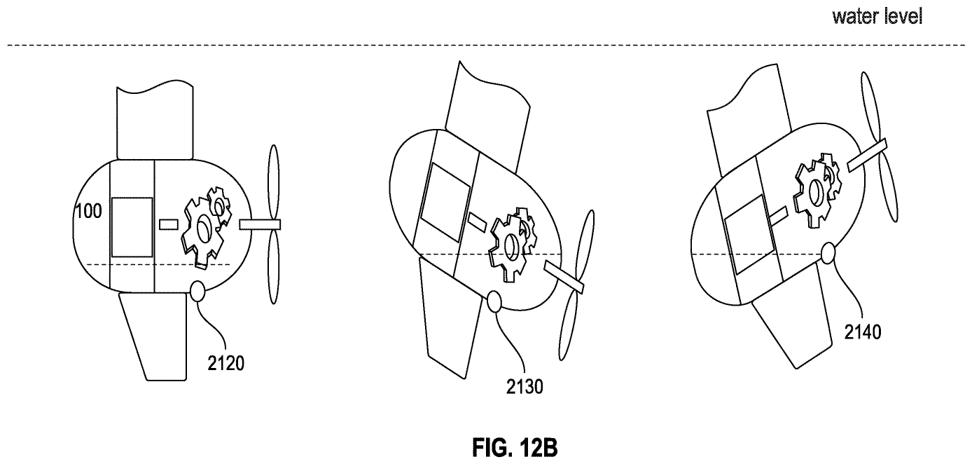

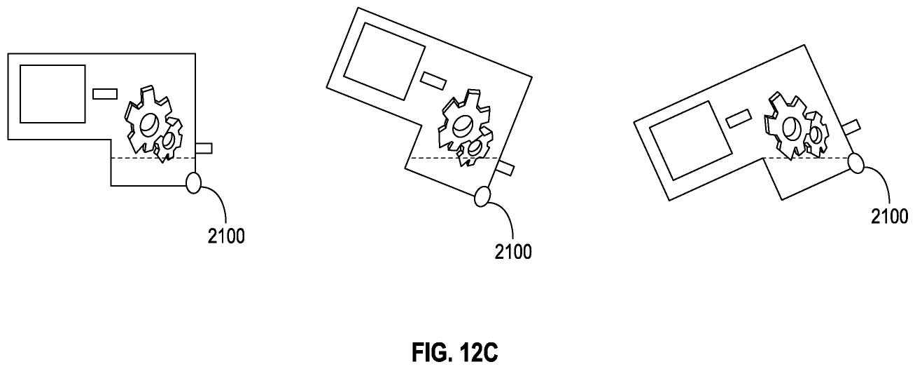

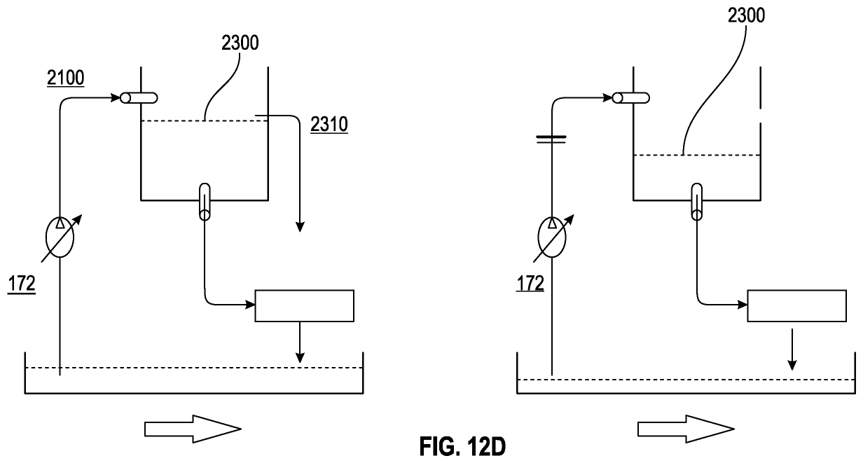

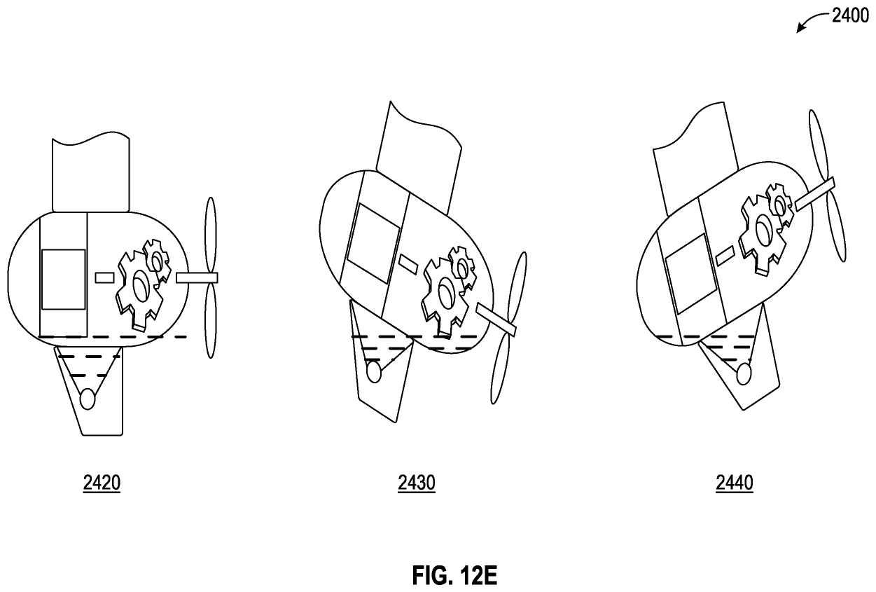

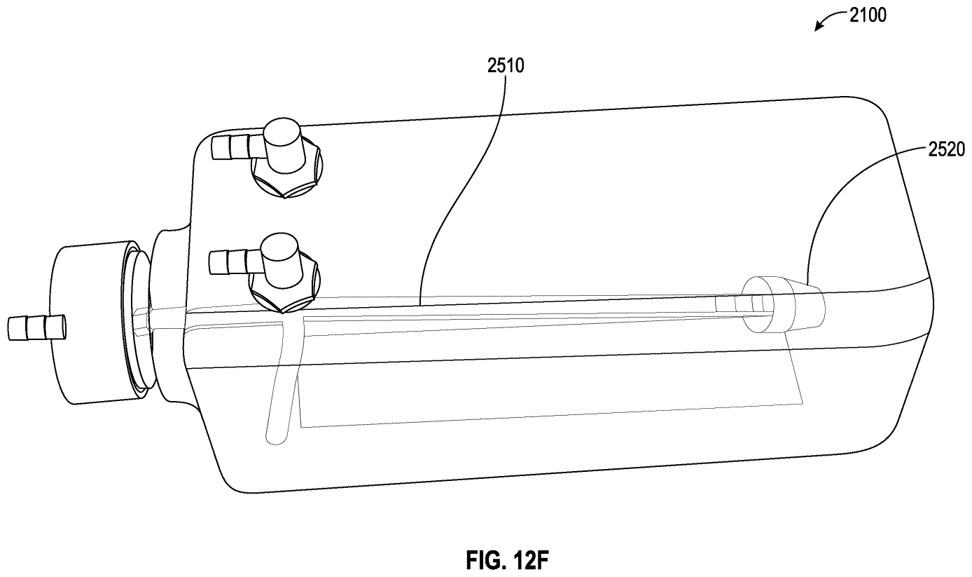

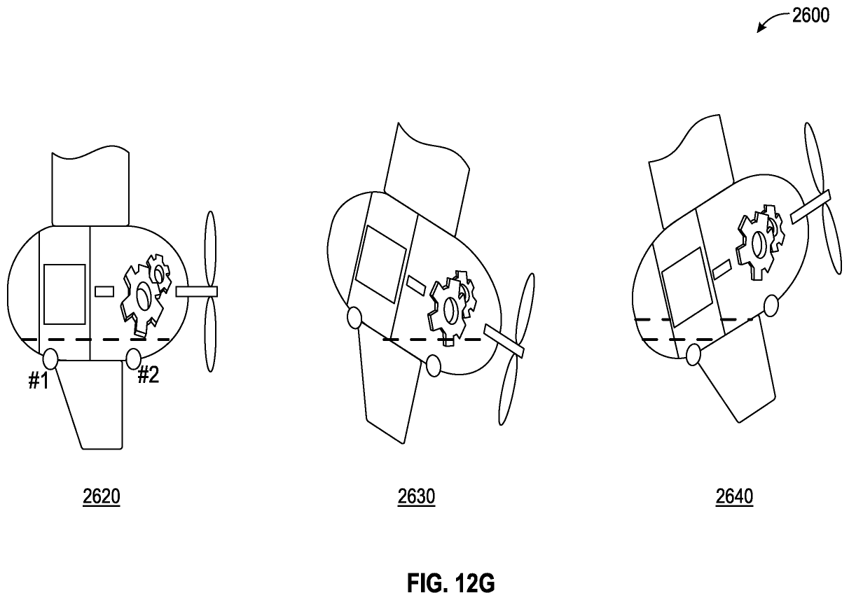

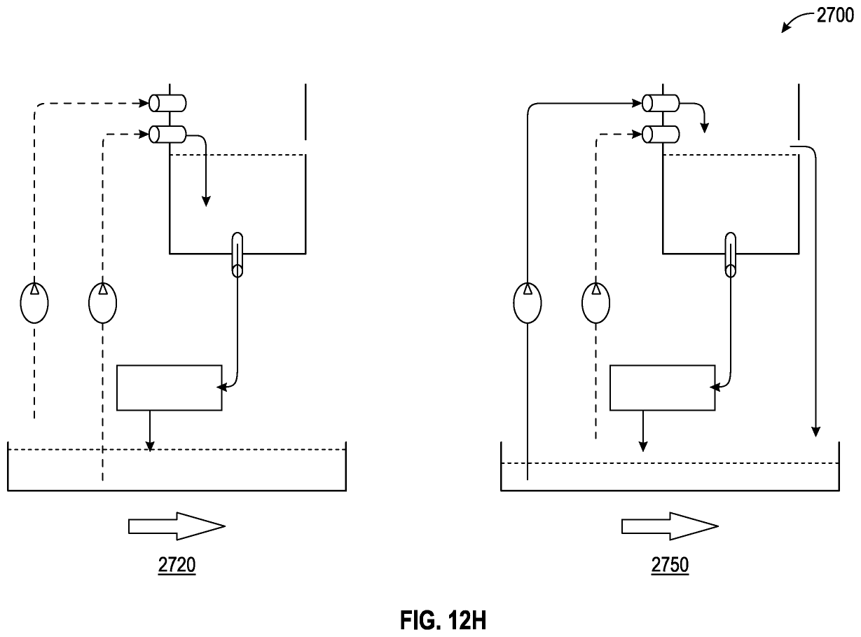

In the above-described motor cooling systems, the cooling liquid is sprayed or dripped onto the motor for cooling. In some embodiments, the motor cooling system 1500 may further comprise a tank (see FIG. 12D) that is installed above the surface of the stored cooling liquid in the underwater pod 100. The tank stores a portion of the cooling liquid. The mechanical gear pump 1540 is configured to pump the cooling liquid from the storage into the tank, and the tank is configured with an outlet through which the cooling liquid stored in the tank drips onto the motor or the speed gearbox.

In the various motor cooling systems described above, the underwater pod 100 functions as a storage of the cooling liquid. The surface of the cooling liquid stays level when the underwater pod 100 is motionless. When the motor cooling system is used in a marine vessel operating in waves, the vessel will experience different motions that can impact the performance of the motor cooling system as the cooling liquid shifts in the underwater pod 100 when the vessel is swayed by the waves. FIG. 12A illustrates different motions of a ship when operating in open water.

In FIG. 12A, a ship is shown to have six degrees of freedom. All motions are measured relative to the ship itself. For reference, the front of the ship is called the bow, the rear of the boat is the stern, the right side of the ship the starboard (when standing in the ship facing the front), the left side of the ship the port, and the body of the ship the hull. The six types of motion are surge, sway, heave, roll, pitch, and yaw. Surge describes the forward and back direction (forward is in the direction the bow is pointing and back is in the direction of the stern). Sway is the side-to-side direction. Heave is moving in the vertical direction. Roll is rotational motion around the surge axis. Yaw is the rotational motion or turning about the heave axis. Pitch is the rotational motion about the sway axis. When pitching, the bow and stern are moving vertically in opposite directions, e.g., when the bow is moving up and the stern is moving down, or vice versa. Pitch is positive when the bow is up relative to a level ship. Pitch is negative when the bow is down relative to a level ship. The first three motions are linear motions and the last three are rotational motions. All six motions described above shift the cooling liquid inside the underwater pod 100. Pitch however has the most impact on the performance of the motor cooling system.

When the ship is pitching, the hull of the ship is tilted. So is the underwater pod 100. The cooling liquid accumulated at the bottom of the underwater pod 100 is not level. FIG. 12B illustrates three positions in which a pitching ship goes through. In FIG. 12B, the underwater pod 100 is submerged beneath the water level. In position 2120, the ship is level. In position 2130, the bow is up relative to the level position shown in 2120 and the pitch is positive. In position 2140, the bow is down relative to the level position shown in 2120 and the pitch is negative.

When the inlet of a gear pump is not submerged in the cooling liquid, the cooling liquid cannot flow into the pump and the motor cooling system 30 becomes empty when the cooling liquid can flow out but not flow in. For example, in FIG. 12B, the inlet 2100 is located next to the backend of the keel and the position of the inlet 2100 of a gear is not always submerged in the cooling liquid. In FIG. 12B, the inlet 2100 stays below the cooling liquid when the ship is level and in a positive pitch. But the inlet 2100 is above the surface of the cooling liquid when the ship is in a negative pitch.

FIG. 12C illustrates a solution to the problem illustrated in FIG. 12B. FIG. 12C shows a suitable location for the inlet 2100. The inlet 2100 is located at the lowest point near the stern. The inlet 2100 stays below the surface of the cooling liquid no matter whether the ship is level, in a positive pitch, or in a negative pitch. Also, in FIG. 12C, the square box represents the motor 120 and the gears represent the speed gearbox 160. The motor 120 is disposed in a first region and the speed gearbox 160 is disposed in a second region. The first region is raised above the second region. In this embodiment, the cooling liquid is confined in the second region and does not enter into the first region. Contact between the motor 120 and the cooling liquid is avoided. This arrangement is desirable in scenarios when the motor 120 powered by new energy sources.

FIG. 12D illustrates another solution to the problem illustrated in FIG. 12B. In FIG. 12D, the motor cooling system 30 comprises a cooling liquid tank 2300. The tank 2300 stores a portion of the cooling liquid. A tank pump 172 is configured to pump the cooling liquid from the storage bin (inside the underwater pod 100, for example) into the tank 2300, and the tank is configured with an outlet through which the cooling liquid stored in the tank 2300 drips onto the motor 120 or the speed gearbox 160. The tank 2300 is configured with a spill outlet 2310 to allow the cooling liquid to spill over onto the storage bin. When the inlet 2100 remains below the surface of the cooling liquid in the storage bin, the tank pump 172 continues to pump the cooling liquid into the tank 2300. When in the storage bin, the inflow of the cooling liquid exceeds the outflow of the cooling liquid, the liquid level in the storage bin becomes low. When the inlet 2100 to the tank 2300 is above the liquid level in the storage bin, the tank pump 172 stops pumping the cooling liquid into the tank 2300. However, the cooling liquid continues to flow out the tank 2300 via the outlet at the bottom and via the spill outlet 2310 so that the liquid level in the storage bin will gradually rise.

FIG. 12E illustrates yet another suitable location for the inlet 2100. In this embodiment, the storage bin of the cooling liquid extends downward into the keel. The inlet 2100 is located at the lowest point of the storage bin inside the keel. When the inlet 2100 is deep enough inside the keel, the inlet 2100 remains submerged in the cooling liquid in all three positions illustrated in FIG. 12E. Further, using the keel as a storage for the cooling liquid increases the heat exchange surface between the cooling liquid and surrounding water. The keel defines a flat area that includes two contact surfaces on opposing sides of the flat region. The two contact surfaces serve as heat-exchange surfaces between the cooling liquid and surrounding water when the boat is in operation.

FIG. 12F illustrates another configuration of the inlet 2100. The storage bin inside the underwater pod 100 is configured with a movable inlet 2100 that remains submerged in the cooling liquid even when the ship is in a rough condition at sea. The movable inlet 2100 is configured as a cylindrical tube or a straw 2510. The opening of the tube or straw forms an inlet. The tube or straw 2510 includes a weight 2520 attached to the end to ensure that the opening of the tube or straw 2510 remains submerged inside the cooling liquid.

FIG. 12G illustrates yet another configuration 2600 of the inlet 2100. In FIG. 12G, the storage bin is configured with two pumps and two inlets, inlet #1 and inlet #2, that are positioned at a distance apart from each other. Each inlet is connected to each pump respectively. As shown in FIG. 12G, at least one of the two inlets is submerged in the cooling liquid when the boat is in a pitch position. The corresponding pump connected to the at least one inlet submerged in the cooling liquid is in operation to pump the cooling liquid from the storage. In one embodiment, the inlet corresponding to the first pump is located in the front of the storage and the inlet corresponding to the second pump is located at the back of the storage. Because at least one inlet is submerged in the cooling liquid, at least one of the two pumps is in operation.

FIG. 12H illustrates an embodiment in which the tank is configured with an overflow port to allow the cooling liquid to flow into the storage located below the tank to prevent the tank from overflowing. In one scenario, a flow of a first pump in the two pumps is larger than a flow of the overflow port, and a flow of the overflow port is larger than a flow of a second pump in the two pumps. Whether the boat is in a negative or position pitch position, one of the two pumps is operating and the flow rate of the cooling liquid being pumped into the tank stays appropriately adjusted as compared to the overflow rate. In some embodiments, the motor cooling system is installed in the hull and an exchange valve is disposed at a bottom of the hull to facilitate draining and changing of the cooling liquid. In some embodiments, an exchange tube connects to the storage at one end and connects to the outside of the hull at the other end, The exchange tube is used to receive the cooling liquid from the storage when the exchange tube is connected to an outside pump during draining or changing of the cooling liquid.

Although the disclosure is illustrated and described herein with reference to specific embodiments, the disclosure is not intended to be limited to the details shown. Rather, various modifications may be made in the details within the scope and range of equivalents of the claims and without departing from the disclosure.

What is claimed is:

1. An electric motor cooling system, comprising:
an electric motor;
a speed gearbox operatively coupled to the electric motor; and
a sealed chamber encasing the electric motor and the speed gearbox and configured to store a cooling liquid; and
a stirring component disposed inside the sealed chamber,
wherein the stirring component is configured to transfer momentum to the cooling liquid to move the cooling liquid to at least one of the electric motor or the speed gearbox when the electric motor is in operation.

2. The electric motor cooling system of claim 1, wherein the stirring component is a component of the speed gearbox; and
wherein one or more gears of the speed gearbox are configured to transfer momentum to the cooling liquid when in operation such that the cooling liquid spreads over at least one of the electric motor or the speed gearbox and the cooling liquid absorbs thermal energy from at least one of the electric motor or the speed gearbox.

3. The electric motor cooling system of claim 1, wherein the electric motor cooling system is configured for a boat and is at least partially submerged in water during an operation of the boat, and wherein, when the boat is at least partially disposed in the water, the electric motor cooling system is configured to exchange thermal energy with the water.

4. The electric motor cooling system of claim 1, wherein the cooling liquid comprises a coolant or a lubricant configured to communicate with at least one of the electric motor or the speed gearbox.

5. The electric motor cooling system of claim 1, wherein the stirring component is a component of the electric motor; and
wherein a rotor of the electric motor is configured to stir the cooling liquid when in operation such that the cooling liquid spreads over at least one of the electric motor or the speed gearbox and the cooling liquid absorbs thermal energy from at least one of the electric motor or the speed gearbox.

6. The electric motor cooling system of claim 1, wherein the electric motor and the speed gearbox each define one or more orifices through which the cooling liquid reaches internal parts of the electric motor or the speed gearbox for lubrication and heat exchange.

7. The electric motor cooling system of claim 1, further comprising:
a pump disposed in the sealed chamber, wherein the pump is configured to fluidly receive the cooling liquid from a lower portion of the sealed chamber and to pump the received cooling liquid to an upper portion of the sealed chamber at an elevation above at least one of the electric motor or the speed gearbox.

8. The electric motor cooling system of claim 7, wherein the pump is disposed between the electric motor and the speed gearbox.

9. The electric motor cooling system of claim 7, wherein the pump is configured to receive the cooling liquid through one or more inlet ports and comprises a filter in at least one of the one or more inlet ports to filter out debris collected from the cooling liquid.

10. The electric motor cooling system of claim 9, wherein one or more outlet ports of the pump are disposed in proximity to the electric motor; and
wherein a portion of the pumped cooling liquid output from the one or more outlet ports contacts interior portions of the electric motor to perform at least one of cooling or lubricating the electric motor.

11. The electric motor cooling system of claim 9, wherein one or more outlet ports of the pump are disposed in proximity to the speed gearbox; and
wherein a portion of the pumped cooling liquid output from the one or more outlet ports contacts interior portions of the speed gearbox to perform at least one of cooling or lubricating the gearbox.

12. The electric motor cooling system of claim 9, wherein the pump further comprises one or more valves, each of the one or more valves being disposed inside an outlet port of the pump to control a flow rate of the cooling liquid flowing through the outlet port.

13. A motor cooling system, comprising:
an engine that includes a speed gearbox and a motor;
a sealed chamber encasing the motor and the speed gearbox and configured to store a cooling liquid; and
a pump configured to receive the cooling liquid from the sealed chamber and to output the received cooling liquid over the speed gearbox.

14. The motor cooling system of claim 13, wherein the pump is further configured to output the received cooling liquid over the motor.

15. The motor cooling system of claim 13, wherein the motor and the speed gearbox are separately installed in a first region and a second region of the sealed chamber respectively, and the first region is above the second region; and wherein a portion of the sealed chamber extends beneath the second region where the speed gearbox is installed, and wherein the cooling liquid stored in the sealed chamber is substantially constrained within the second region.

16. The motor cooling system of claim 14, wherein one or more rotors of the motor are encased in a sealed cover to prevent contact with the cooling liquid, and a stator and a shaft of the motor are in contact with the cooling liquid.

17. The motor cooling system of claim 13, further comprising a tank,
wherein the tank is installed above a surface of the cooling liquid in the sealed chamber, and the tank stores a portion of the cooling liquid, and
wherein a tank pump is configured to draw the cooling liquid from the sealed chamber into the tank, and the tank is configured with an outlet through which the cooling liquid stored in the tank drips onto at least one of the motor or the speed gearbox.

18. The motor cooling system of claim 13, wherein the motor cooling system is installed in a boat,
wherein the sealed chamber is configured with a movable inlet that remains submerged in the cooling liquid when the boat is in motion, and wherein the movable inlet is a cylindrical tube and comprises a weight attached to an end of the cylindrical tube to ensure the cylindrical tube stay submerged in the cooling liquid.

19. The motor cooling system of claim 13, wherein the motor cooling system is installed in a boat,
wherein the sealed chamber is configured with a pair of pumps and a pair of inlets that are positioned a distance apart, wherein each inlet is connected to a respective pump, and wherein the pair of inlets are positioned such that when the boat is in motion, at least one of the pair of inlets is submerged in the cooling liquid and the respective pump connected to the at least one of the pair of inlets submerged in the cooling liquid is in operation to pump the cooling liquid from the sealed chamber into a tank.

20. The motor cooling system of claim 13, comprising at least one of the following:
wherein the motor cooling system is installed in an underwater pod and wherein an exchange valve is disposed on a lower surface of the underwater pod to facilitate at least one of draining or changing the cooling liquid;
wherein the motor cooling system further comprises an above-water electric cooling device, wherein the above-water electric cooling device comprises a tube bundle arranged in a honey-comb style, and wherein the cooling liquid received from the sealed chamber passes through spaces in between tubes in the tube bundle and exchanges heat with tube surfaces of the tube bundle;
wherein an exchange tube connects to the sealed chamber at one end and connects to outside of the underwater pod at another end, and wherein the exchange tube is configured to receive the cooling liquid from the sealed chamber when the exchange tube is connected to an outside pump when at least one of draining or changing the cooling liquid is performed;
wherein the motor cooling system further comprises the above-water electric cooling device disposed in an above-water electronic control bay in an above-water powerhead;
wherein the motor cooling system is connected to a steering gear system of a boat, and wherein the motor cooling liquid is configured to adjust a temperature of the steering gear system or configured to lubricate the steering gear system;
wherein the motor cooling system is connected to a tilt-and-trim system of the boat and the cooling liquid is pumped from the motor cooling system to the tilt-and-trim system to adjust a temperature of the tilt-and-trim system; or
wherein the motor cooling system is installed in the boat, and wherein the cooling liquid, after absorbing thermal energy from the engine, is directed to a heating system of the boat to adjust a temperature of a living quarter of the boat.
